(19) United States
(12) Patent Application Publication
(10) Pub. No.: US 2013/0257738 A1
(43) Pub. Date: Oct. 3, 2013

(54) NUMERICAL CONTROL APPARATUS

(71) Applicant: Takahisa Tanaka, Tokyo (JP)

(72) Inventor: Takahisa Tanaka, Tokyo (JP)

(73) Assignee: MITSUBISHI ELECTRIC CORPORATION, Tokyo (JP)

(21) Appl. No.: 13/990,999

(22) PCT Filed: Dec. 2, 2010
(86) PCT No.: PCT/JP2010/071586

§ 371 Date: May 31, 2013

(51) Int. Cl. G06F 3/041

(52) U.S. Cl. CPC G06F 3/0416
USPC 345/168

(57) ABSTRACT

A numerical control apparatus controls a machine tool. The numerical control apparatus includes a display unit that includes a main display screen, a keyboard unit that includes a plurality of input keys and an auxiliary display screen on an operation surface, and a display control unit that displays first machine-related information related to the machine tool on the main display screen and displays second machine-related information related to the machine tool on the auxiliary display screen. The keyboard unit includes a display input unit that receives an input instruction by using the auxiliary display screen as a touch panel.

### FIELD

The present invention relates to a numerical control apparatus.

### BACKGROUND

Patent Literature 1 describes that a laptop has a liquid crystal display that is attached to the inner surface of the cover and a keyboard and an auxiliary liquid crystal display that are mounted on the top surface of the chassis, with the auxiliary liquid crystal display being smaller than the liquid crystal display. Thus, according to Patent Literature 1, a specific text stored in a memory can be displayed on the auxiliary liquid crystal display during an editing operation by a word processor; therefore, the efficiency of the editing operation by the word processor can be improved.

Patent Literature 2 describes that a word processor is configured such that an auxiliary display, which is provided with a touch panel on its surface, is rotatably attached to the lower portion of the main display chassis, to which a main display is fixed, and a tilt dial for rotating the auxiliary display projects from the front and back surfaces of the auxiliary display. Thus, according to Patent Literature 2, even with the main display chassis closed, a printing function can be performed by displaying the surface of the auxiliary display by rotating the tilt dial and then pressing the touch panel.

### CITATION LIST

### Patent Literature

Patent Literature 1: Japanese Patent Application Laid-open H08-161079
Patent Literature 2: Japanese Patent Application Laid-open H06-35567

### SUMMARY

### Technical Problem

On the other hand, a numerical control (Numerical Control: hereinafter referred to as NC) apparatus exists that includes a display unit and a keyboard unit. The display unit displays a screen that indicates the state of the NC apparatus and the keyboard unit is used to perform a screen operation via keystrokes. In such an NC apparatus, the input keys (for example, alphanumeric keys) on the keyboard unit are uniquely defined depending on the hardware and the screen operation is performed by using the defined input keys. Therefore, there is a tendency for the number of keystrokes to be large and the operability to be low.

Moreover, an NC apparatus exists that includes an object for a keyboard as a touch panel on a display unit and with which a user can intuitively perform an operation by displaying a screen and performing the screen operation on the same unit (display unit). In such an NC apparatus, because the object for a keyboard occupies part of the display screen, the amount of information that can be displayed on the screen is limited and therefore the operability tends to be low.

In Patent Literature 1 and Patent Literature 2, it is assumed that an apparatus such as a laptop or a word processor for inputting text is used and there is no description of how to improve the operability when a machine tool is controlled by an NC apparatus (numerical control apparatus).

The present invention is achieved in view of the above and an object of the present invention is to obtain a numerical control apparatus capable of improving the operability when a machine tool is controlled.

### Solution to Problem

In order to solve the above problems and achieve the object, the numerical control apparatus according to one aspect of the present invention controls a machine tool and includes a display unit that includes a main display screen, a keyboard unit that includes a plurality of input keys and an auxiliary display screen on an operation surface, and a display control unit that displays first machine-related information related to the machine tool on the main display screen and displays second machine-related information related to the machine tool on the auxiliary display screen. The keyboard unit includes a display input unit that receives an input instruction by using the auxiliary display screen as a touch panel.

### Advantageous Effects of Invention

According to the present invention, an input instruction corresponding to a plurality of inputs via the input keys can be performed by one input via the touch panel; therefore, the number of inputs with respect to an input instruction can be reduced. The objects for the touch panel do not occupy any part of the main display screen; therefore, the amount of information that can be displayed on the screen can be maintained. Thus, the number of screen transitions necessary to handle a predetermined amount of information can be reduced. As a result, the operability when controlling a machine tool can be improved.

### BRIEF DESCRIPTION OF DRAWINGS

FIG. 1 is a diagram illustrating the configuration of a numerical control apparatus according to a first embodiment.

FIG. 2 is a diagram illustrating the configuration of the numerical control apparatus according to the first embodiment.

FIG. 3 is a flowchart illustrating operations of screens according to the first embodiment.

FIG. 4 is a diagram illustrating operations of the screens according to the first embodiment.

FIG. 5 is a diagram illustrating operations of the screens according to the first embodiment.

FIG. 6 is a flowchart illustrating operations of screens according to a second embodiment.

FIG. 7 is a diagram illustrating operations of the screens according to the second embodiment.

FIG. 8 is a flowchart illustrating operations of screens according to a third embodiment.

FIG. 9 is a diagram illustrating operations of the screens according to the third embodiment.

FIG. 10 is a flowchart illustrating operations of screens according to a fourth embodiment.

FIG. 11 is a diagram illustrating operations of the screens according to the fourth embodiment.

FIG. 12 is a flowchart illustrating operations of screens according to a fifth embodiment.

FIG. 13 is a diagram illustrating operations of the screens according to the fifth embodiment.

FIG. 14 is a flowchart illustrating operations of screens according to a sixth embodiment.

FIG. 15 is a diagram illustrating operations of the screens according to the sixth embodiment.

FIG. 16 is a diagram illustrating the configuration of a screen according to a comparison example.

### DESCRIPTION OF EMBODIMENTS

Embodiments of a numerical control apparatus according to the present invention will be described in detail below with reference to the drawings. This invention is not limited to these embodiments.

### First Embodiment

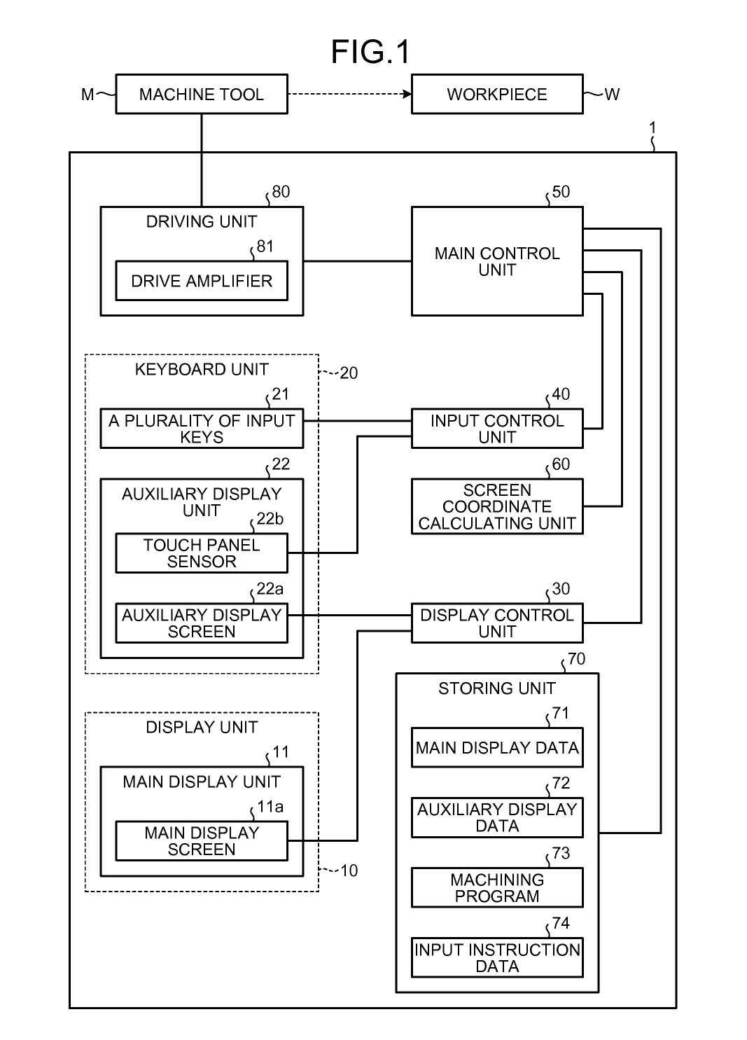

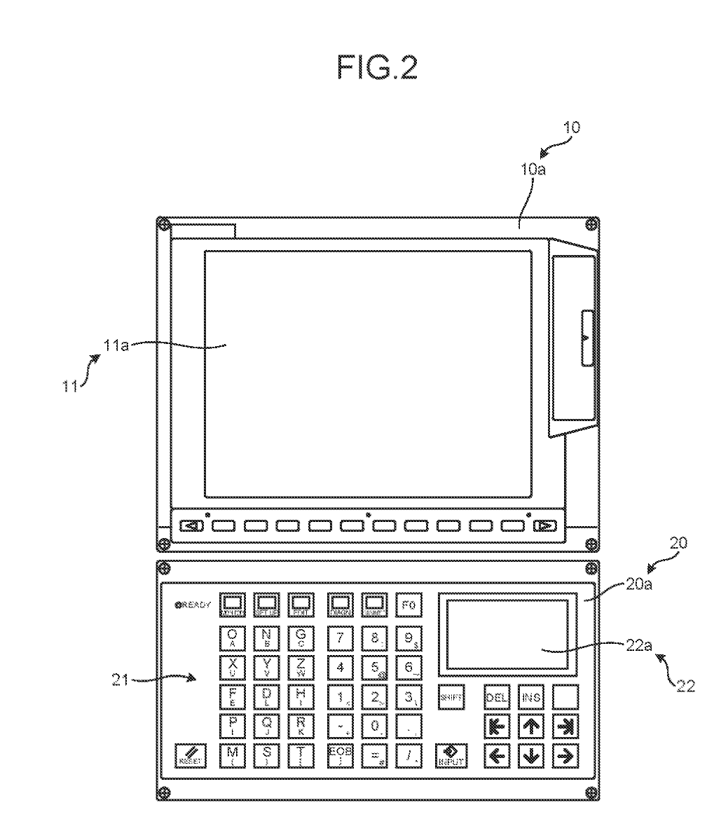

A numerical control apparatus 1 according to the first embodiment will be explained with reference to FIG. 1 and FIG. 2. FIG. 1 is a diagram illustrating the functional configuration of the NC apparatus 1. FIG. 2 is a diagram illustrating the exterior configuration of the NC apparatus 1.

The numerical control apparatus (hereinafter, referred to as NC apparatus) 1 numerically controls the operation of a machine tool M (a tool attached thereto). For example, the NC apparatus 1 controls machining of a workpiece W by the machine tool M.

Specifically, the NC apparatus 1 includes a main control unit 50, a display unit 10, a keyboard unit 20, an input control unit 40, a display control unit 30, a storing unit 70, a screen coordinate calculating unit 60, and a driving unit 80.

The main control unit 50 performs overall control of the display unit 10, the keyboard unit 20, the input control unit 40, the display control unit 30, the screen coordinate calculating unit 60, the storing unit 70, and the driving unit 80.

The display unit 10 includes a main display screen 11a on a main surface 10a that faces a user when the user uses the NC apparatus 1 (see FIG. 2). Specifically, the display unit 10 includes a main display unit 11. The main display unit 11 displays, on the main display screen 11a, an image in accordance with an image signal supplied from the display control unit 30. For example, the main display unit 11 displays first machine-related information related to the machine tool M on the main display screen 11a. For example, the first machine-related information includes basic information on the NC state and the NC operation. Alternatively, for example, the first machine-related information includes a machining program 73 that is being edited.

The keyboard unit 20 includes a plurality of input keys 21 and an auxiliary display screen 22a on an operation surface 20a that is operated by a user when the user uses the NC apparatus 1 (see FIG. 2). The auxiliary display screen 22a is arranged, for example, on the upper right of the operation surface 20a.

Specifically, the keyboard unit 20 includes the input keys 21 and an auxiliary display unit 22. The input keys 21 receive a predetermined instruction from a user in accordance with the key that is pressed. The input keys 21 include, for example, a plurality of alphanumeric keys and other predetermined keys (see FIG. 2). For example, a user operates the NC apparatus 1 by pressing predetermined alphanumeric keys among the input keys 21 while checking the display content on the main display screen 11a.

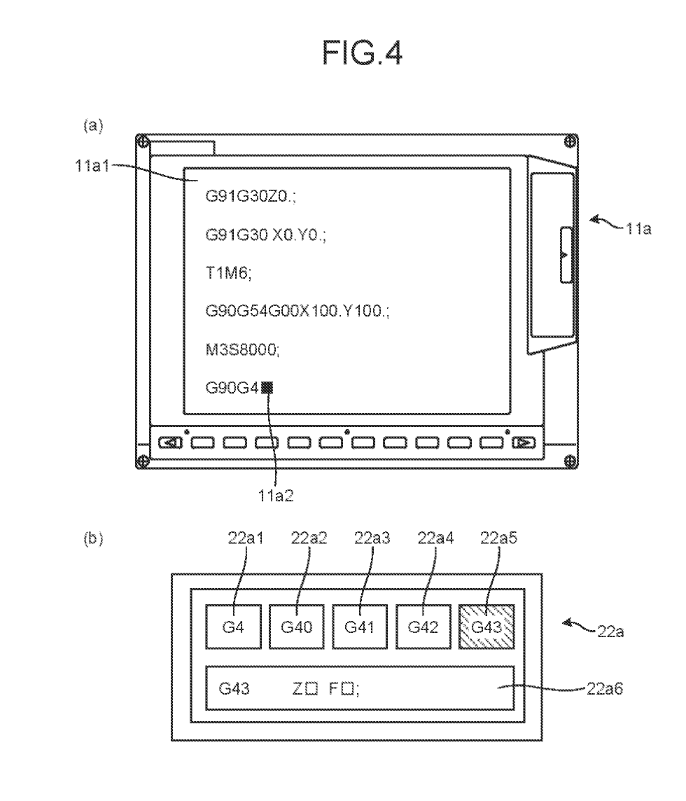

The auxiliary display unit 22 displays, on the auxiliary display screen 22a, an image in accordance with an image signal supplied from the display control unit 30. For example, the auxiliary display unit 22 displays second machine-related information related to the machine tool M. The second machine-related information includes, for example, a plurality of button objects linked to the first machine-related information (see FIG. 4).

Moreover, the auxiliary display unit 22 includes a touch panel sensor (display input unit) 22b. The touch panel sensor 22b receives an input instruction by using the auxiliary display screen 22a as a touch panel. For example, a user operates the NC apparatus 1 by pressing a predetermined portion on the auxiliary display screen 22a while checking the display content on the main display screen 11a. For example, the touch panel sensor 22b receives an input instruction corresponding to the pressed button object among a plurality of button objects (see FIG. 4).

When any of the input keys 21 are pressed, the input control unit 40 detects which key is pressed and supplies pressed-key information, which indicates which key is pressed, to the main control unit 50. The main control unit 50 performs control in accordance with the pressed-key information.

Moreover, when any portion on the auxiliary display screen 22a is pressed, the input control unit 40 detects which portion on the auxiliary display screen 22a is pressed via the touch panel sensor 22b and supplies pressed-touch-panel information, which indicates which portion is pressed, to the main control unit 50. The main control unit 50 performs control in accordance with the pressed-touch-panel information.

The display control unit 30 controls each of the information to be displayed on the main display screen 11a and the information to be displayed on the auxiliary display screen 22a in accordance with the control performed by the main control unit 50. Specifically, the display control unit 30 generates main display data 71 to be displayed on the main display screen 11a, converts the main display data 71 to an image signal for display, and supplies the converted image signal for display to the main display unit 11. In addition, the display control unit 30 generates auxiliary display data 72 to be displayed on the auxiliary display screen 22a, converts the auxiliary display data 72 to an image signal for display, and supplies the converted image signal for display to the auxiliary display unit 22. Thus, the display control unit 30 displays the first machine-related information related to the machine tool M on the main display screen 11a and displays the second machine-related information related to the machine tool M on the auxiliary display screen 22a.

The storing unit 70 stores the machining program 73 used when the NC apparatus 1 controls machining of the workpiece W by the machine tool M. For example, a motion trajectory of the machine tool M is contained within the machining program 73.

Moreover, the storing unit 70 is also used as a predetermined working area. For example, the storing unit 70 stores the main display data 71 generated by the display control unit 30 as data to be displayed on the main display screen 11a and stores the auxiliary display data 72 generated by the display control unit 30 as data to be displayed on the auxiliary display screen 22a. Furthermore, the storing unit 70 stores input instruction data 74 generated by the main control unit 50 as data that indicates the association between a plurality of coordinates on the auxiliary display screen 22a and a plurality of input instructions.

The screen coordinate calculating unit 60 receives the pressed-touch-panel information from the input control unit 40 via the main control unit 50 and calculates and specifies the coordinates on the auxiliary display screen 22a indicated by the pressed-touch-panel information. Moreover, the screen coordinate calculating unit 60 reads the input instruction data 74 from the storing unit 70 via the main control unit 50 and calculates and specifies a plurality of coordinates included in the input instruction data 74. The screen coordinate calculating unit 60 compares the coordinates on the auxiliary display screen 22a indicated by the pressed-touch-panel information with a plurality of coordinates included in the input instruction data 74. The screen coordinate calculating unit 60 determines whether the coordinate position indicated by the pressed-touch-panel information is included within a predetermined radius centered on any of a plurality of coordinates included in the input instruction data 74 in the whole region of the auxiliary display screen 22a. When the coordinate position indicated by the pressed-touch-panel information is included within the predetermined radius centered on the coordinates that are associated with a predetermined input instruction and are included in the input instruction data 74, the screen coordinate calculating unit 60 determines that the predetermined input instruction has been received.

Consequently, the screen coordinate calculating unit 60 supplies the input instruction received by the touch panel sensor 22b to the main control unit 50 as touch-panel-input-instruction information. Due to the touch-panel-input-instruction information being supplied, the main control unit 50 recognizes that the input instruction in accordance with the touch-panel-input-instruction information has been received via the touch panel sensor 22b.

The driving unit 80 drives the machine tool M such that machining of the workpiece W by the machine tool M is performed in accordance with the control performed by the main control unit 50. Specifically, the driving unit 80 includes a drive amplifier 81. The driving unit 80 receives an instruction to drive the machine tool M from the main control unit 50, generates a drive signal by amplifying the received instruction by using the drive amplifier 81, and supplies it to the machine tool M. Consequently, the machine tool M is driven.

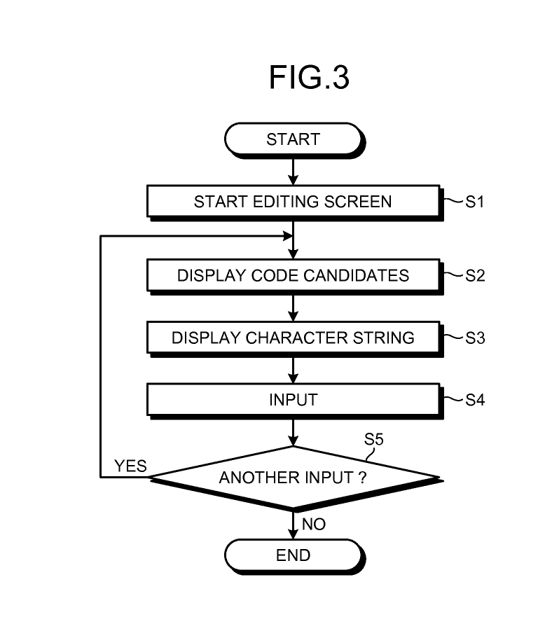

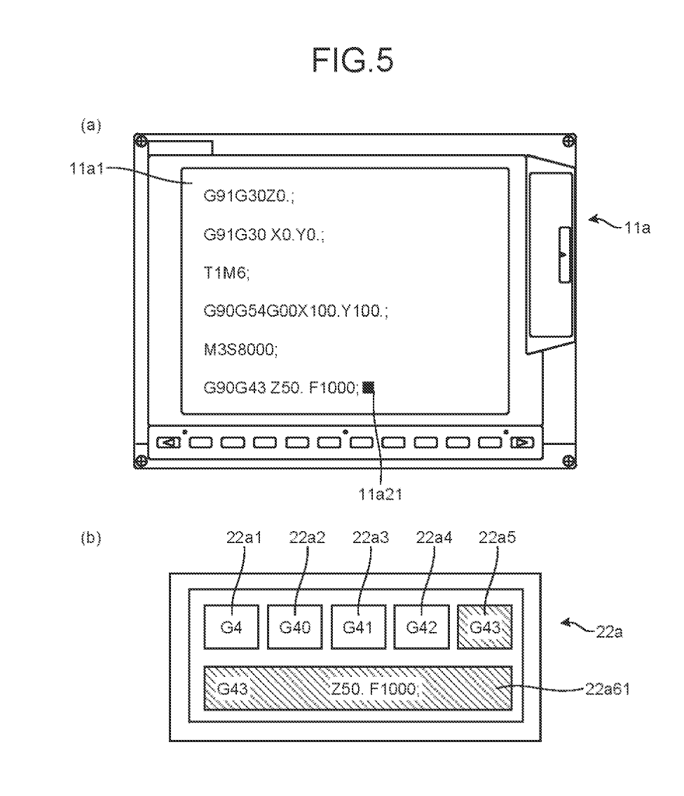

Next, an explanation is given with reference to FIG. 3 to FIG. 5 of an editing screen for the machining program 73, which is frequently used by the NC apparatus 1. FIG. 3 is a flowchart illustrating operations of the main display screen 11a and the auxiliary display screen 22a. FIG. 4(a) and FIG. 5(a) are diagrams illustrating an operation of the main display screen 11a. FIG. 4(b) and FIG. 5(b) are diagrams illustrating an operation of the auxiliary display screen 22a.

In Step S1 illustrated in FIG. 3, the input control unit 40 detects that a start instruction to start the editing screen for the machining program 73 has been received from a user via at least one of the input keys 21 and the touch panel sensor 22b. The input control unit 40 supplies the detected start instruction to the main control unit 50. In response to the supplied start instruction, the main control unit 50 accesses the storing unit 70 and determines whether the machining program 73 being edited is stored in the storing unit 70.

When the machining program 73 being edited is not stored in the storing unit 70, the main control unit 50 supplies information indicating the absence of the machining program 73 being edited to the display control unit 30. Consequently, the display control unit 30 generates, as the main display data 71, an editing screen 11a1 for the machining program 73 in the initial state.

In contrast, when the machining program 73 being edited is stored in the storing unit 70, the main control unit 50 supplies the information on the machining program 73 being edited to the display control unit 30. Consequently, the display control unit 30 generates, as the main display data 71, the editing screen 11a1 for the machining program 73 by including the information on the machining program 73 being edited.

Then, the display control unit 30 stores the main display data 71 in the storing unit 70 via the main control unit 50, converts the main display data 71 to an image signal for display, and supplies it to the main display unit 11. Consequently, the main display unit 11 starts the editing screen 11a1 for the machining program 73 and displays it on the main display screen 11a. At this point, the main display unit 11 displays a cursor (for example, the black square object illustrated in FIG. 4(a)) 11a2, which indicates the edit position, at the initial position in the machining program 73 in the initial state or at the position of the last portion in the machining program 73 being edited.

In Step S2, the main control unit 50 controls the display control unit 30 such that a plurality of button objects corresponding to a plurality of codes that are candidates to be added next to the machining program 73 are displayed on the auxiliary display screen 22a.

For example, when the machining program 73 being edited is not stored in the storing unit 70, the main control unit 50 predicts a plurality of codes that are candidates to be added next to the machining program 73 in the initial state on the basis of the NC parameters set to specify the machine tool M that is a control target. The main control unit 50 supplies the predicted codes to the display control unit 30. The display control unit 30 generates, as the auxiliary display data 72, a plurality of button objects (not illustrated) corresponding to the codes. The display control unit 30 stores the auxiliary display data 72 in the storing unit 70 via the main control unit 50, converts the auxiliary display data 72 to an image signal for display, and supplies it to the auxiliary display unit 22. Consequently, the auxiliary display unit 22 displays, on the auxiliary display screen 22a, a plurality of button objects (candidate codes that are expected to be input first) as information linked to the description (blank description) at the position of the cursor 11a2 on the editing screen 11a1 for the machining program 73 in the initial state.

In contrast, for example, when the machining program 73 being edited is stored in the storing unit 70, the main control unit 50 predicts a plurality of codes that are candidates to be added next to the machining program 73 being edited on the basis of the description of the last portion in the machining program 73 being edited. For example, the main control unit 50 predicts G codes “G4”, “G40”, “G41”, “G42”, and “G43” as candidates to be added next to the machining program 73 being edited (see FIG. 4(b)). The main control unit 50 supplies the predicted codes to the display control unit 30. The display control unit 30 generates, as the auxiliary display data 72, a plurality of button objects 22a1 to 22a5 (see FIG. 4(b)) corresponding to the codes (for example, G codes “G4”, “G40”, “G41”, “G42”, and “G43”). The display control unit 30 stores the auxiliary display data 72 in the storing unit 70 via the main control unit 50, converts the auxiliary display data 72 to an image signal for display, and supplies it to the auxiliary display unit 22. Consequently, the auxiliary display unit 22 displays the button objects 22a1 to 22a5 on the auxiliary display screen 22a as information linked to the description at the position of the cursor 11a2 on the editing screen 11a1 for the machining program 73 being edited.

Moreover, for example, when the main control unit 50 recognizes that the cursor 11a2 on the editing screen 11a1 for the machining program 73 is moved via the input keys 21, the main control unit 50 predicts a plurality of new codes that are candidates to be added next to the machining program 73 being edited on the basis of the description of the portion at which the moved cursor 11a2 is present. The main control unit 50 supplies the predicted codes to the display control unit 30. The display control unit 30 generates, as the auxiliary display data 72, a plurality of button objects (not illustrated) corresponding to the codes. The display control unit 30 stores the auxiliary display data 72 in the storing unit 70 via the main control unit 50, converts the auxiliary display data 72 to an image signal for display, and supplies it to the auxiliary display unit 22. Consequently, the auxiliary display unit 22 displays the button objects 22a1 to 22a5 (which are dynamically changed) on the auxiliary display screen 22a as information linked to the description at the position of the cursor 11a2 on the editing screen 11a1 for the machining program 73 being edited.

In Step S3, the main control unit 50 controls the display control unit 30 such that a character string that is expected to be input next to the code corresponding to the selected button object is displayed on the auxiliary display screen 22a.

For example, when the main control unit 50 recognizes that one of the button objects is selected via the touch panel sensor 22b, the main control unit 50 predicts a character string that is expected to be input next to the code corresponding to the selected button object. For example, when the main control unit 50 recognizes that the button object 22a5 corresponding to the G code “G43” is selected via the touch panel sensor 22b, the main control unit 50 notifies the display control unit 30 that the button object 22a5 is selected. In response to this, the display control unit 30 updates the auxiliary display data 72 in the storing unit 70 via the main control unit 50 and controls the auxiliary display unit 22 such that it displays an indication that the button object 22a5 is selected (for example, by highlighting the button object 22a5 as illustrated in FIG. 4(b)).

In addition, when the main control unit 50 recognizes that the button object 22a5 corresponding to the G code “G43” is selected, the main control unit 50 predicts a program instruction format “Z F;” of the G43 as a character string that is expected to be input next to the G code “G43”. The main control unit 50 supplies the predicted character string “Z F;” to the display control unit 30. The display control unit 30 generates, as the auxiliary display data 72, a button object 22a6 (see FIG. 4(b)) corresponding to the character string “Z F;”. The display control unit 30 updates the auxiliary display data 72 in the storing unit 70 via the main control unit 50, converts the auxiliary display data 72 to an image signal for display, and supplies it to the auxiliary display unit 22. Consequently, the auxiliary display unit 22 displays, on the auxiliary display screen 22a, the button object 22a6 that is linked to the description at the position of the cursor 11a2 on the editing screen 11a1 for the machining program 73 on the main display screen 11a and the button objects 22a1 to 22a5 on the auxiliary display screen 22a.

Moreover, for example, when the main control unit 50 recognizes that a different new button object among the button objects is selected via the touch panel sensor 22b, the main control unit 50 predicts a new character string that is expected to be input next to the code corresponding to the selected button object. In response to this, the display control unit 30 updates the auxiliary display data 72 in the storing unit 70 via the main control unit 50 and controls the auxiliary display unit 22 such that it displays an indication that a different new button object is selected (for example, by highlighting the different button object).

In addition, the main control unit 50 supplies the predicted character string to the display control unit 30. The display control unit 30 generates, as the auxiliary display data 72, a button object (not illustrated) corresponding to the character string. The display control unit 30 updates the auxiliary display data 72 in the storing unit 70 via the main control unit 50, converts the auxiliary display data 72 to an image signal for display, and supplies it to the auxiliary display unit 22. Consequently, the auxiliary display unit 22 displays, on the auxiliary display screen 22a, the button object 22a6 (which is dynamically changed) that is linked to the description at the position of the cursor 11a2 on the editing screen 11a1 for the machining program 73 on the main display screen 11a and the button objects 22a1 to 22a5 on the auxiliary display screen 22a.

In Step S4, the main control unit 50 controls the display control unit 30 such that a value is input to the character string displayed on the auxiliary display screen 22a in Step S3.

For example, when the main control unit 50 recognizes that the portion “ ” after “Z” in the character string “Z F;” on the auxiliary display screen 22a is pressed via the touch panel sensor 22b, the main control unit 50 notifies the display control unit 30 that the portion “ ” after “Z” is pressed. In response to this, the display control unit 30 updates the auxiliary display data 72 in the storing unit 70 via the main control unit 50 and controls the auxiliary display unit 22 such that it displays an indication that a value can be input to the pressed portion “ ”, i.e., the instruction value of Z can be input (for example, by displaying the portion “ ” with a black square).

Then, when the main control unit 50 recognizes that, for example, “50.” is input as the instruction value of Z via the input keys 21, the main control unit 50 notifies the display control unit 30 of the instruction value “50.” of Z. In response to this, the display control unit 30 updates the auxiliary display data 72 in the storing unit 70 via the main control unit 50 and controls the auxiliary display unit 22 such that it displays an indication that “50.” is input to the pressed portion “ ”, i.e., “50.” is input as the instruction value of Z (for example, by displaying “Z50. F;”).

For example, when the main control unit 50 recognizes that the portion “ ” after “F” in the character string “Z50. F” on the auxiliary display screen 22a is pressed via the touch panel sensor 22b, the main control unit 50 notifies the display control unit 30 that the portion “ ” after “F” is pressed. In response to this, the display control unit 30 updates the auxiliary display data 72 in the storing unit 70 via the main control unit 50 and controls the auxiliary display unit 22 such that it displays an indication that a value can be input to the pressed portion “ ”, i.e., the instruction value of F can be input (for example, by displaying the portion “ ” with a black square).

Then, when the main control unit 50 recognizes that, for example, “1000” is input as the instruction value of F via the input keys 21, the main control unit 50 notifies the display control unit 30 of the instruction value “1000” of F. In response to this, the display control unit 30 updates the auxiliary display data 72 in the storing unit 70 via the main control unit 50 and controls the auxiliary display unit 22 such that it displays an indication that “1000” is input to the pressed portion “ ”, i.e., “1000” is input as the instruction value of F (for example, by displaying “Z50. F1000;” as illustrated in FIG. 5(b)).

Furthermore, when the main control unit 50 detects that the button object 22a6 is pressed (for example, a portion other than the instruction value of Z and the instruction value of F in the button object 22a6 is pressed) via the touch panel sensor 22b, the main control unit 50 controls the display control unit 30 such that the character string “Z50. F1000;” on the auxiliary display screen 22a is also displayed on the main display screen 11a. In other words, the main control unit 50 notifies the display control unit 30 that the button object 22a6 is pressed. In response to this, the display control unit 30 updates the auxiliary display data 72 in the storing unit 70 via the main control unit 50 and controls the auxiliary display unit 22 such that it displays an indication that the button object 22a6 is selected (for example, by highlighting a button object 22a61 as illustrated in FIG. 5(b)). In response to the notification that the button object 22a6 is pressed, the display control unit 30 reads the main display data 71 from the storing unit 70 via the main control unit 50 and generates the new main display data 71 obtained by adding the G code “G43” and the character string “Z50. F1000;” to the main display data 71. The display control unit 30 updates the main display data 71 in the storing unit 70 via the main control unit 50, converts the main display data 71 to an image signal for display, and supplies it to the main display unit 11. Consequently, the main display unit 11 inserts the G code “G43” and the character string “Z50. F1000;” at the position of the cursor (for example, the black square object illustrated in FIG. 4(a)) 11a2 on the editing screen 11a1 for the machining program 73 and display it on the main display screen 11a (see FIG. 5(a)). In response to this, the main display unit 11 displays a cursor 11a21 at the last position of the description after the insertion on the main display screen 11a.

In Step S5, the main control unit 50 determines whether there is another input.

For example, when the input control unit 40 detects that an end instruction to end the editing screen 11a1 for the machining program 73 has been received from a user via at least one of the input keys 21 and the touch panel sensor 22b, the input control unit 40 supplies the detected end instruction to the main control unit 50.

When the end instruction is supplied from the input control unit 40 within a predetermined time, the main control unit 50 determines that there is no other input and ends the process. When the end instruction is not supplied from the input control unit 40 within a predetermined time, the main control unit 50 determines that there is another input and returns the process to Step S2.

A case is considered here in which the keyboard unit 20 of the NC apparatus 1 does not include the auxiliary display screen 22a and the touch panel sensor 22b. In such a case, the input keys (for example, alphanumeric keys) on the keyboard unit 20 are uniquely defined depending on the hardware and the screen operation is performed by using the defined input keys. Therefore, there is a tendency for the number of keystrokes with respect to a predetermined input instruction to be large and the operability to be low.

In contrast, in the first embodiment, the keyboard unit 20 of the NC apparatus 1 includes the auxiliary display screen 22a and the touch panel sensor 22b. The touch panel sensor 22b receives an input instruction by using the auxiliary display screen 22a as a touch panel. Consequently, an input instruction corresponding to a plurality of inputs via the input keys can be performed by one input via the touch panel. Therefore, the number of inputs with respect to an input instruction can be reduced and thus the operability can be improved. In other words, the operability when controlling the machine tool M can be improved.

Specifically, the display control unit 30 displays, on the auxiliary display screen 22a, the button objects 22a1 to 22a5 linked to the first machine-related information on the main display screen 11a as part of the second machine-related information. The touch panel sensor 22b receives an input instruction corresponding to the pressed button object among the button objects 22a1 to 22a5. Consequently, an input instruction with respect to a button object corresponding to a plurality of inputs via the input keys can be performed by one input via the touch panel. Therefore, the number of inputs with respect to an input instruction can be reduced and thus the operability can be improved.

Particularly, the display control unit 30 displays the machining program 73 being edited on the main display screen 11a as the first machine-related information and displays the button objects 22a1 to 22a5 corresponding to a plurality of codes that are candidates to be added next to the machining program 73 being edited on the auxiliary display screen 22a as part of the second machine-related information. The touch panel sensor 22b receives an input instruction to input a code corresponding to the pressed button object among the button objects 22a1 to 22a5. Consequently, incorrect inputs (input of a description of an incorrect machining program instruction) can be reduced while reducing the number of inputs with respect to an input instruction.

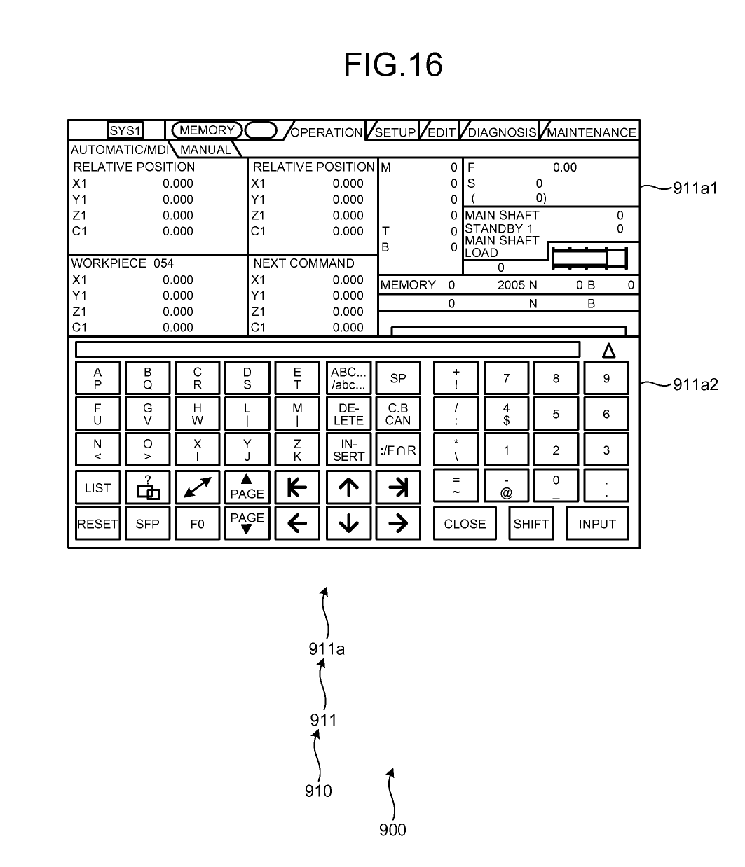

Alternatively, a case is considered in which an NC apparatus 900 does not include the keyboard unit 20. In such a case, as illustrated in FIG. 16, a display part 911 of a display unit 910 includes an object 911a2 for a keyboard on a display screen 911a as a touch panel. With the NC apparatus 900 in this case, although it is possible to perform an operation in accordance with a display content 911a1 by selecting the content 911a1 displayed on the display screen 911a via the touch panel (the object 911a2 for a keyboard), part of the display screen 911a is occupied by the object 911a2 for a keyboard; therefore, the amount of information (the amount of information on the display content 911a1) that can be displayed on the screen is limited. Thus, there is a tendency for the number of screen transitions necessary to handle a predetermined amount of information to be large and the operability to be low.

In contrast, in the first embodiment, the objects for the touch panel do not occupy any part of the main display screen 11a; therefore, the amount of information that can be displayed on the screen can be maintained. In other words, the display control unit 30 displays the first machine-related information related to the machine tool M on the main display screen 11a and displays the second machine-related information related to the machine tool M on the auxiliary display screen 22a. Consequently, the number of screen transitions necessary to handle a predetermined amount of information can be reduced and thus the operability can be improved. In other words, the operability when controlling the machine tool M can be improved.

Specifically, the display control unit 30 displays the information linked to the first machine-related information on the auxiliary display screen 22a as the second machine-related information. Consequently, when it is necessary to check the second machine-related information that is the information related to the first machine-related information, the second machine-related information can be checked without performing a screen transition. Therefore, the necessary number of screen transitions can be reduced and thus the operability can be improved.

More specifically, the display control unit 30 displays the machining program 73 being edited on the main display screen 11a as the first machine-related information and displays the button objects 22a2 to 22a5 linked to the machining program 73 being edited on the auxiliary display screen 22a as part of the second machine-related information. Consequently, it is possible to reduce the necessity to transition to another screen to check a code added to the machining program 73; therefore, the operability can be improved.

Particularly, with the machining program 73 for controlling the machine tool M, a code to be used next (in the G code or the like) is easily narrowed down; therefore, it is possible to cover the codes that have a high probability of being used next and display them on the auxiliary display screen 22a as the button objects 22a1 to 22a5.

Furthermore, the display control unit 30 displays, on the auxiliary display screen 22a, a character string that is expected to be input next to the code corresponding to the selected button object as another part of the second machine-related information. Consequently, it is possible to reduce the necessity to transition to another screen to check a code to be added to the machining program 73 next to the code; therefore, the operability can be further improved.

Moreover, in the first embodiment, the keyboard unit 20 includes the input keys 21 and the auxiliary display screen 22a, which functions as a touch panel, on the operation surface 20a. Consequently, the operability can be improved when the input operation via the input keys 21 and the input operation via the touch panel sensor 22b are consecutively performed.

Furthermore, in the first embodiment, the auxiliary display screen 22a is arranged, for example, on the upper right of the operation surface 20a. Consequently, the distance between the main display screen 11a and the auxiliary display screen 22a can be reduced. Therefore, the operability can be improved when the main display screen 11a and the auxiliary display screen 22a are compared with each other. Moreover, even when a large number of input keys are arranged in the portion other than the auxiliary display screen 22a in the operation surface 20a, it is possible to reduce cases of the auxiliary display screen 22a being covered by a hand or an arm of a user when the user is operating the input keys. Thus, the operability can be improved when the display content of the auxiliary display screen 22a is checked while operating the input keys 21.

In the flowchart illustrated in FIG. 3, the process in Step S2 and the process in Step S3 may be performed in parallel after the process in Step S1 is performed. Alternatively, the process in Step S3 may be performed after the process in Step S1 and the process in Step S2 are performed in parallel. Alternatively, the process in Step S1, the process in Step S2, and the process in Step S3 may be performed in parallel.

### Second Embodiment

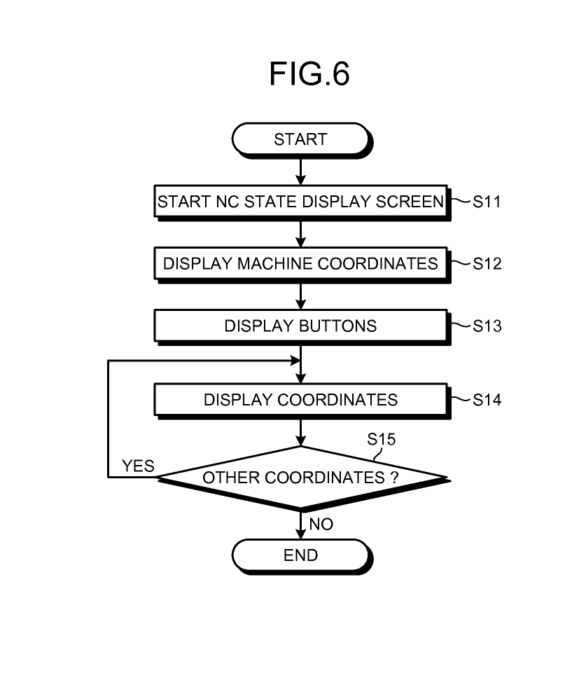

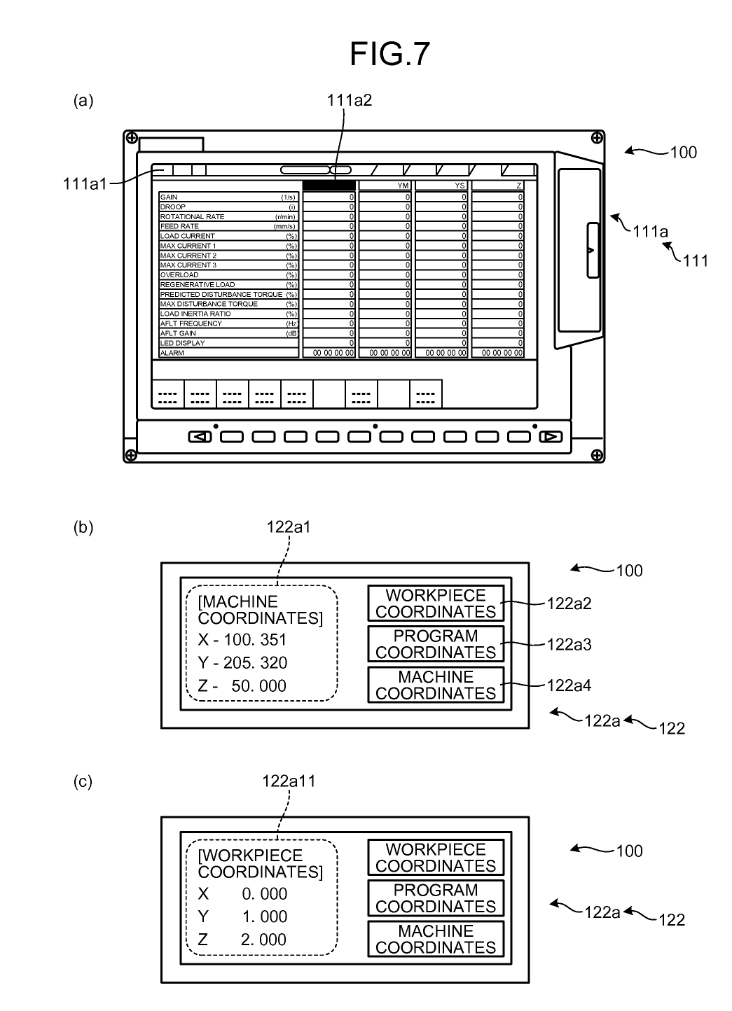

Next, an NC apparatus 100 according to the second embodiment will be explained with reference to FIG. 6 and FIG. 7. FIG. 6 is a flowchart illustrating operations of a main display screen 111a and an auxiliary display screen 122a according to the second embodiment. FIG. 7(a) is a diagram illustrating an operation of the main display screen 111a. FIGS. 7(b) and (c) are diagrams illustrating an operation of the auxiliary display screen 122a. In the following, the explanation concentrates on the portions that are different from the first embodiment.

In Step S11 illustrated in FIG. 6, the input control unit 40 detects that a start instruction to start an NC state display screen has been received from a user via at least one of the input keys 21 and the touch panel sensor 22b. The input control unit 40 supplies the detected start instruction to the display control unit 30 via the main control unit 50.

The display control unit 30 generates an NC state display screen 111a1 (see FIG. 7(a)) as the main display data 71 in accordance with the supplied start instruction. Then, the display control unit 30 stores the main display data 71 in the storing unit 70 via the main control unit 50, converts the main display data 71 to an image signal for display, and supplies it to a main display unit 111. Consequently, the main display unit 111 starts the NC state display screen 111a1 and displays it on the main display screen 111a. At this point, the main display unit 111 displays a cursor (for example, the black square object illustrated in FIG. 7(a)) 111a2, which indicates the edit position, at the initial position on the NC state display screen 111a1. For example, the main display unit 111 displays, as the NC state display screen 111a1, a screen that indicates the state of the drive amplifier 81 in the driving unit 80 on the main display screen 111a.

In Step S12, the input control unit 40 detects that a display instruction to display machine coordinates has been received from a user via at least one of the input keys 21 and the touch panel sensor 22b. The input control unit 40 supplies the detected display instruction to the display control unit 30 via the main control unit 50.

The display control unit 30 generates machine coordinate information 122a1 (see FIG. 7(b)), which indicates the position of the machine, as the auxiliary display data 72 in accordance with the supplied display instruction. The display control unit 30 stores the auxiliary display data 72 in the storing unit 70 via the main control unit 50, converts the auxiliary display data 72 to an image signal for display, and supplies it to an auxiliary display unit 122. Consequently, the auxiliary display unit 122 displays the machine coordinate information 122a1 in accordance with the display instruction on the auxiliary display screen 122a.

In Step S13, the main control unit 50 controls the display control unit 30 such that a plurality of button objects linked to the machine coordinate information 122a1 are displayed on the auxiliary display screen 122a.

For example, the main control unit 50 predicts information candidates that are related to the machine coordinate information 122a1 and to which reference is made. For example, the main control unit 50 predicts “workpiece coordinates”, “program coordinates”, and “machine coordinates” as the information candidates that are related to the machine coordinate information 122a1 and to which reference is made (see FIG. 7(b)). The workpiece coordinates are coordinates of the workpiece W to be machined by the machine tool M and are coordinates of the center of the workpiece W with reference to the origin on the workpiece W. The program coordinates are coordinates of the machine tool M (a tool attached to the machine tool M) when instructed by the machining program 73 and are coordinates obtained by adding a tool correction amount to the position at which the machine tool M is currently instructed to be. The machine coordinates are coordinates of the machine tool M (a tool attached to the machine tool M).

The main control unit 50 supplies a plurality of predicted information candidates to the display control unit 30. The display control unit 30 generates, as the auxiliary display data 72, information that includes a plurality of button objects 122a2 to 122a4 (see FIG. 7(b)) corresponding to a plurality of information candidates (“workpiece coordinates”, “program coordinates”, and “machine coordinates”) in addition to the machine coordinate information 122a1. The display control unit 30 updates the auxiliary display data 72 in the storing unit 70 via the main control unit 50, converts the auxiliary display data 72 to an image signal for display, and supplies it to the auxiliary display unit 122. Consequently, the auxiliary display unit 122 displays the button objects 122a2 to 122a4 on the auxiliary display screen 122a as information linked to the machine coordinate information 122a1.

In Step S14, the main control unit 50 controls the display control unit 30 such that coordinates selected from among “workpiece coordinates”, “program coordinates”, and “machine coordinates” are displayed on the auxiliary display screen 122a.

For example, when the main control unit 50 recognizes that one button object is selected from among a plurality of button objects via the touch panel sensor 22b, the main control unit 50 obtains the coordinates corresponding to the selected button object. For example, when the main control unit 50 recognizes that “workpiece coordinates” are selected via the touch panel sensor 22b, the main control unit 50 calculates information on the workpiece coordinates by subtracting a workpiece coordinate offset value stored in the storing unit 70 from the machine coordinate value. The main control unit 50, for example, obtains “X 0.000 Y 1.000 Z 2.000” as information on the workpiece coordinates (see FIG. 7(c)). The main control unit 50 supplies the obtained workpiece coordinates to the display control unit 30. The display control unit 30 updates the auxiliary display data 72 in the storing unit 70 via the main control unit 50, converts the auxiliary display data 72 to an image signal for display, and supplies it to the auxiliary display unit 122. Consequently, the auxiliary display unit 122 displays workpiece coordinate information 122a11 on the auxiliary display screen 122a instead of the machine coordinate information 122a1.

Alternatively, for example, when the main control unit 50 recognizes that “program coordinates” are selected via the touch panel sensor 22b, the main control unit 50 calculates information on the program coordinates by referring to the tool correction amount by which the tool is currently instructed to be corrected. The main control unit 50 supplies the obtained program coordinates to the display control unit 30. The display control unit 30 updates the auxiliary display data 72 in the storing unit 70 via the main control unit 50, converts the auxiliary display data 72 to an image signal for display, and supplies it to the auxiliary display unit 122. Consequently, the auxiliary display unit 122 displays program coordinate information (not illustrated) on the auxiliary display screen 122a instead of the machine coordinate information 122a1.

In Step S15, the main control unit 50 determines whether it is requested to display other coordinates.

For example, when the input control unit 40 detects that an end instruction to end the NC state display screen 111a1 has been received from a user via at least one of the input keys 21 and the touch panel sensor 22b, the input control unit 40 supplies the detected end instruction to the main control unit 50.

When the end instruction is supplied from the input control unit 40 within a predetermined time, the main control unit 50 determines that it is not requested to display other coordinates and ends the process. When the end instruction is not supplied from the input control unit 40 within a predetermined time, the main control unit 50 determines that it is requested to display other coordinates and returns the process to Step S14.

As described above, in the second embodiment also, the objects for the touch panel do not occupy the main display screen 111a; therefore, the amount of information that can be displayed on the screen can be maintained. In other words, the display control unit 30 displays the first machine-related information related to the machine tool M on the main display screen 111a and displays the second machine-related information related to the machine tool M on the auxiliary display screen 122a. Consequently, the number of screen transitions necessary to handle a predetermined amount of information can be reduced and thus the operability can be improved. In other words, the operability when controlling the machine tool M can be improved.

Specifically, the display control unit 30 displays the NC state display screen 111a1, which indicates the state of the drive amplifier 81 in the driving unit 80, on the main display screen 111a and displays the machine coordinate information 122a1, which indicates the coordinates of the machine tool M, on the auxiliary display screen 122a. Consequently, when it is necessary to check the coordinates of the machine tool M driven by the drive amplifier 81 at the same time as the state of the drive amplifier 81, both of them can be checked without causing the NC state display screen 111a1 on the main display screen 111a to transition to the machine coordinate screen. Therefore, the necessary number of screen transitions can be reduced and thus the operability can be improved.

Moreover, in the second embodiment, the display control unit 30 displays the button objects 122a2 to 122a4 linked to part of the second machine-related information (the machine coordinate information 122a1) on the auxiliary display screen 122a as another part of the second machine-related information. The touch panel sensor 22b receives an input instruction corresponding to the pressed button object among the button objects 122a2 to 122a4. Consequently, the coordinate value to be displayed on the auxiliary display screen 122a can be changed. In other words, when another coordinate value needs to be checked following the coordinates of the machine tool M, it can be checked without causing the NC state display screen 111a1 on the main display screen 111a to transition to the machine coordinate screen; therefore, the necessary number of screen transitions can be further reduced.

In the flowchart illustrated in FIG. 6, the process in Step S12 and the process in Step S13 may be performed in parallel after the process in Step S11 is performed. Alternatively, the process in Step S13 may be performed after the process in Step S11 and the process in Step S12 are performed in parallel. Alternatively, the process in Step S11, the process in Step S12, and the process in Step S13 may be performed in parallel.

### Third Embodiment

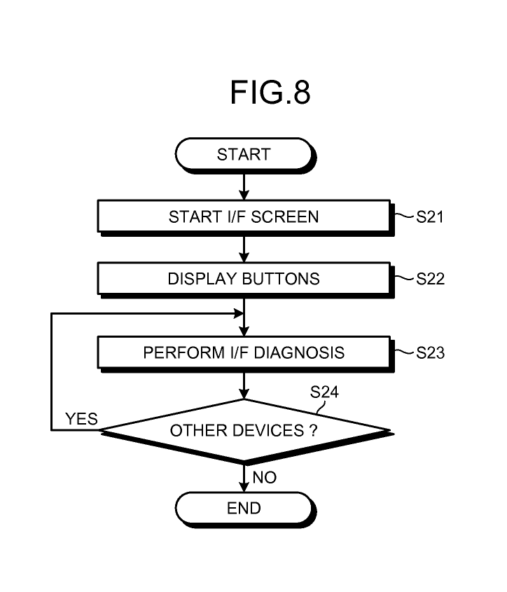

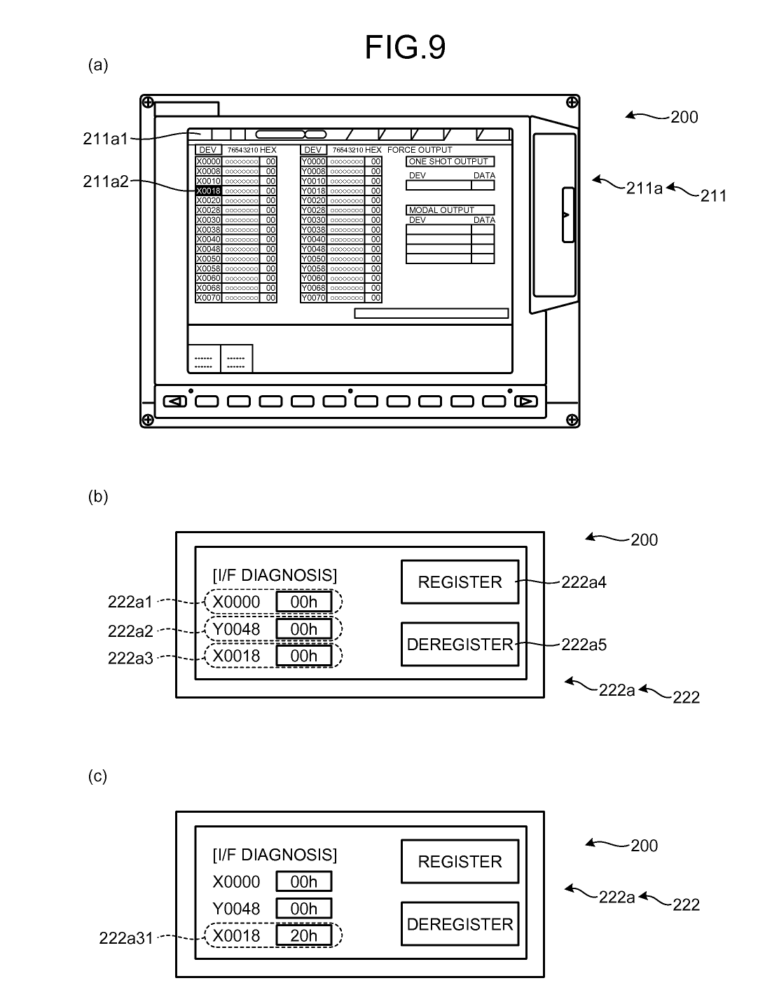

Next, an NC apparatus 200 according to the third embodiment will be explained with reference to FIG. 8 and FIG. 9. FIG. 8 is a flowchart illustrating operations of a main display screen 211a and an auxiliary display screen 222a according to the third embodiment. FIG. 9(a) is a diagram illustrating an operation of the main display screen 211a. FIGS. 9(b) and (c) are diagrams illustrating an operation of the auxiliary display screen 222a. In the following, the explanation concentrates on the portions that are different from the first embodiment.

In Step S21 illustrated in FIG. 8, the input control unit 40 detects that a start instruction to start an I/F screen has been received from a user via at least one of the input keys 21 and the touch panel sensor 22b. The input control unit 40 supplies the detected start instruction to the display control unit 30 via the main control unit 50.

The display control unit 30 generates an I/F screen 211a1 (see FIG. 9(a)) as the main display data 71 in accordance with the supplied start instruction. Then, the display control unit 30 stores the main display data 71 in the storing unit 70 via the main control unit 50, converts the main display data 71 to an image signal for display, and supplies it to a main display unit 211. Consequently, the main display unit 211 starts the I/F screen 211a1 and displays it on the main display screen 211a. At this point, the main display unit 211 displays a cursor (for example, the black square object illustrated in FIG. 9(a)) 211a2, which indicates the edit position, at a predetermined position on the I/F screen 211a1. The main display unit 211 displays the I/F screen 211a1 on the main display screen 211a, and the I/F screen 211a1 is used, for example, for checking the display of various input/output signals for controlling a PLC and a machine sequence operation when a PLC is developed and for checking input/output data between each unit of the NC apparatus and a PLC.

In Step S22, the main control unit 50 controls the display control unit 30 such that a plurality of button objects linked to both the display content of the I/F screen 211a1 and I/F diagnostic information (a plurality of pieces of I/F diagnostic information 222a1 to 222a3 illustrated in FIG. 9(b)) to be displayed are displayed on the auxiliary display screen 222a.

For example, the main control unit 50 predicts operation candidates that are needed for I/F diagnosis (Step S23 which will be described later). For example, the main control unit 50 predicts “register” and “deregister” as operation candidates that are needed for I/F diagnosis (see FIG. 9(b)). The main control unit 50 supplies the predicted operation candidates, i.e., “register” and “deregister”, to the display control unit 30. The display control unit 30 generates, as the auxiliary display data 72, a plurality of button objects 222a4 to 222a5 (see FIG. 9(b)) corresponding to the operation candidates, i.e., “register” and “deregister”. The display control unit 30 stores the auxiliary display data 72 in the storing unit 70 via the main control unit 50, converts the auxiliary display data 72 to an image signal for display, and supplies it to an auxiliary display unit 222. Consequently, the auxiliary display unit 222 displays the button objects 222a4 to 222a5 on the auxiliary display screen 222a as information linked to both the display content of the I/F screen 211a1 and the I/F diagnostic information (the I/F diagnostic information 222a1 to 222a3 illustrated in FIG. 9(b)) to be displayed.

In Step S23, the main control unit 50 controls the display control unit 30 such that the I/F diagnostic information 222a1 to 222a3 is displayed on the auxiliary display screen 222a.

For example, when the main control unit 50 recognizes that the button object 222a4 for “register” is pressed among the button objects 222a4 to 222a5 via the touch panel sensor 22b, the main control unit 50 specifies devices X0000, Y0048, and X0018 at the cursor positions from among a plurality of devices X0000 to X0070 and Y0000 to Y0070 displayed on the I/F screen 211a1 as devices on which the I/F diagnosis needs to be performed, i.e., registering and deregistering need to be determined. The main control unit 50 supplies information on the specified devices X0000, Y0048, and X0018 to the display control unit 30. The display control unit 30 generates, as the auxiliary display data 72, the I/F diagnostic information 222a1 to 222a3 (see FIG. 9(b)) corresponding to the specified devices. The display control unit 30 stores the auxiliary display data 72 in the storing unit 70 via the main control unit 50, converts the auxiliary display data 72 to an image signal for display, and supplies it to the auxiliary display unit 222. Consequently, the auxiliary display unit 222 displays, on the auxiliary display screen 222a, the I/F diagnostic information 222a1 to 222a3 as information linked to the display content (the selected devices) of the I/F screen 211a1. For example, in each piece of the I/F diagnostic information 222a1 to 222a3 illustrated in FIG. 9(b), the information on the left side is an identifier of a device and the information on the right side is data (for example, “00h”).

For example, when the main control unit 50 recognizes that a portion of data (for example, “00h”) of one piece of I/F diagnostic information among the I/F diagnostic information 222a1 to 222a3 is pressed via the touch panel sensor 22b, the main control unit 50 notifies the display control unit 30 of the pressed I/F diagnostic information. For example, when the main control unit 50 recognizes that a portion of the I/F diagnostic information 222a3 is pressed via the touch panel sensor 22b, the main control unit 50 notifies the display control unit 30 that the data portion of the I/F diagnostic information 222a3 is pressed. In response to this, the display control unit 30 updates the auxiliary display data 72 in the storing unit 70 via the main control unit 50 and controls the auxiliary display unit 222 such that it displays an indication that a value can be input to the pressed data portion of the I/F diagnostic information 222a3 (for example, by highlighting the I/F diagnostic information 222a3).

Then, for example, when the main control unit 50 recognizes that “20h” is input via the input keys 21 as a value of the data of the I/F diagnostic information 222a3 (change in data is set), the main control unit 50 notifies the display control unit 30 of the value “20h” of the data of the I/F diagnostic information 222a3. In response to this, the display control unit 30 updates the auxiliary display data 72 in the storing unit 70 via the main control unit 50 and controls an auxiliary display unit 422 such that it displays an indication that “20h” is input instead of “00h” in the pressed data portion of the I/F diagnostic information 222a3 (in other words, displaying I/F diagnostic information 222a31 that includes the value “20h” as new data).

Then, when the main control unit 50 recognizes that the button object 222a5 for “deregister” is pressed among the button objects 222a4 to 222a5 via the touch panel sensor 22b, the main control unit 50 notifies the display control unit 30 that the button object 222a5 for “deregister” is pressed. In response to this, the display control unit 30 deregisters the devices displayed on the auxiliary display screen 222a. In other words, the display control unit 30 deregisters the display of each piece of the I/F diagnostic information 222a1 to 222a3 on the auxiliary display screen 222a.

In Step S24, the main control unit 50 determines whether it is requested to perform I/F diagnosis on other devices.

For example, when the input control unit 40 detects that an end instruction to end the I/F screen 211a1 has been received from a user via at least one of the input keys 21 and the touch panel sensor 22b, the input control unit 40 supplies the detected end instruction to the main control unit 50.

When the end instruction is supplied from the input control unit 40 within a predetermined time, the main control unit 50 determines that it is not requested to display other coordinates and ends the process. When the end instruction is not supplied from the input control unit 40 within a predetermined time, the main control unit 50 determines that it is requested to display other coordinates and returns the process to Step S24.

As described above, in the third embodiment, the display control unit 30 displays, on the auxiliary display screen 222a, the button objects 222a4 to 222a5 linked to both the display content (first machine-related information) of the I/F screen 211a1 and the I/F diagnostic information 222a1 to 222a3 (part of the second machine-related information) as another part of the second machine-related information. The touch panel sensor 22b receives an input instruction corresponding to the pressed button object among the button objects 222a4 to 222a5. Consequently, it is possible to perform I/F diagnosis on a device that is selected from among a plurality of devices displayed on the I/F screen 211a1 and that is displayed on the auxiliary display screen 222a. As a result, the number of inputs with respect to an input instruction that is normally needed to check and change an input/output device can be reduced and the number of screen transitions that is normally needed to check and change an input/output device can be reduced.

In the flowchart illustrated in FIG. 8, the process in Step S22 and the process in Step S23 may be performed in parallel after the process in Step S21 is performed. Alternatively, the process in Step S23 may be performed after the process in Step S21 and the process in Step S22 are performed in parallel. Alternatively, the process in Step S21, the process in Step S22, and the process in Step S23 may be performed in parallel.

### Fourth Embodiment

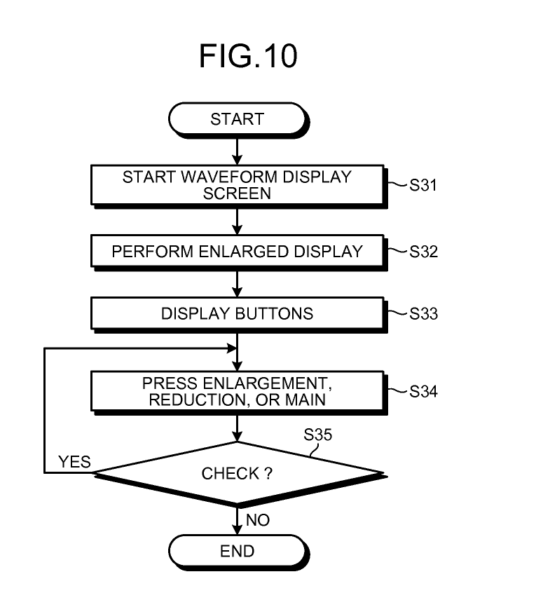

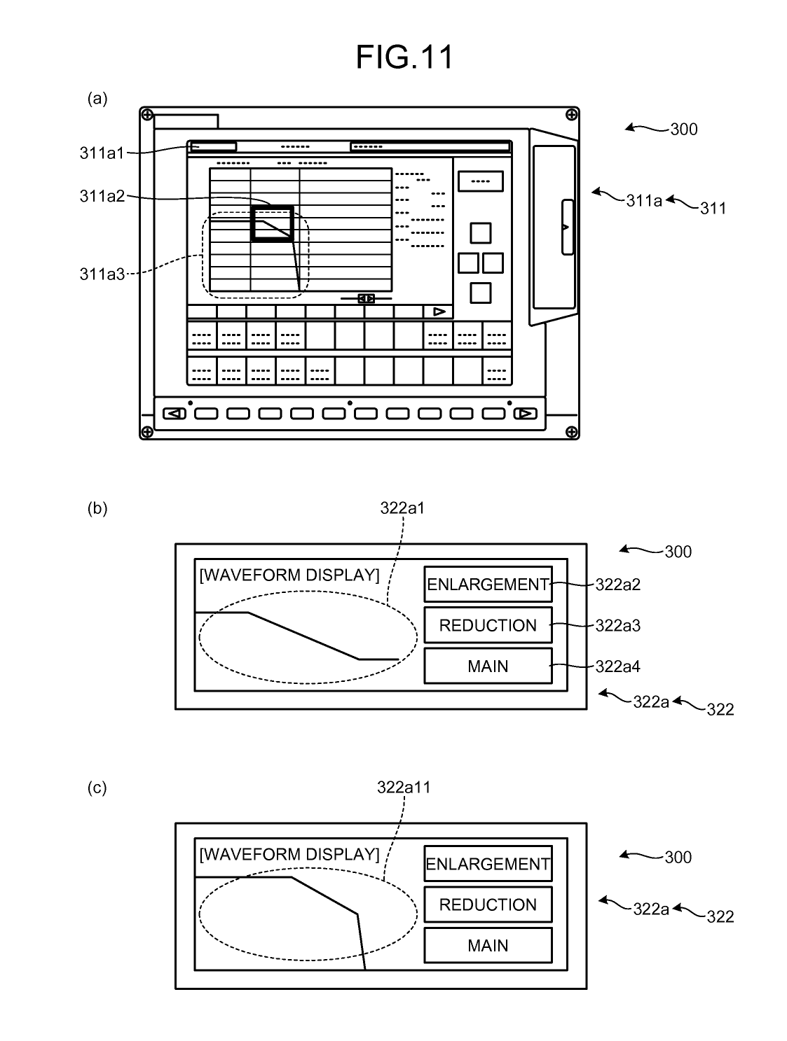

Next, an NC apparatus 300 according to the fourth embodiment will be explained with reference to FIG. 10 and FIG. 11. FIG. 10 is a flowchart illustrating operations of a main display screen 311a and an auxiliary display screen 322a according to the fourth embodiment. FIG. 11(a) is a diagram illustrating an operation of the main display screen 311a. FIGS. 11(b) and (c) are diagrams illustrating an operation of the auxiliary display screen 322a. In the following, the explanation concentrates on the portions that are different from the first embodiment.

In Step S31 illustrated in FIG. 10, the input control unit 40 detects that a start instruction to start a waveform display screen has been received from a user via at least one of the input keys 21 and the touch panel sensor 22b. The input control unit 40 supplies the detected start instruction to the display control unit 30 via the main control unit 50.

The display control unit 30 generates a waveform display screen 311a1 (see FIG. 11(a)) as the main display data 71 in accordance with the supplied start instruction. Then, the display control unit 30 stores the main display data 71 in the storing unit 70 via the main control unit 50, converts the main display data 71 to an image signal for display, and supplies it to a main display unit 311. Consequently, the main display unit 311 starts the waveform display screen 311a1 and displays it on the main display screen 311a. At this point, the main display unit 311 displays a cursor (for example, the square frame illustrated in FIG. 11(a)) 311a2, which indicates the edit position, at a predetermined position on the waveform display screen 311a1. For example, the main display unit 311 displays, on the main display screen 311a, a screen, as the waveform display screen 311a1, that includes a display object 311a3 of a waveform that indicates the operation of a servomotor.

In Step S32, the main control unit 50 controls the display control unit 30 such that a display object obtained by enlarging part of the display object 311a3 on the main display screen 311a is displayed on the auxiliary display screen 322a.

For example, the main control unit 50 specifies a partial display object, which is surrounded by the cursor 311a2, of the display object 311a3 displayed on the waveform display screen 311a1. The main control unit 50 supplies the specified partial display object to the display control unit 30. The display control unit 30 generates, as the auxiliary display data 72, a display object 322a1 (see FIG. 11(b)), which is obtained by enlarging the partial display object such that it corresponds to the region that needs to be displayed on the auxiliary display screen 322a. The display control unit 30 stores the auxiliary display data 72 in the storing unit 70 via the main control unit 50, converts the auxiliary display data 72 to an image signal for display, and supplies it to an auxiliary display unit 322. Consequently, the auxiliary display unit 322 displays the display object 322a1 on the auxiliary display screen 322a as a display object obtained by enlarging part of the display object 311a1 on the waveform display screen 311a1.

Moreover, when the main control unit 50 recognizes that the cursor 311a2 on the waveform display screen 311a1 is moved via the input keys 21, the main control unit 50 specifies a partial display object, which is surrounded by the cursor 311a2 after being moved, of the display object 311a3 displayed on the waveform display screen 311a1. The main control unit 50 supplies the specified partial display object to the display control unit 30. The display control unit 30 generates, as the auxiliary display data 72, a display object (not illustrated) obtained by enlarging the partial display object such that it corresponds to the region that needs to be displayed on the auxiliary display screen 322a. The display control unit 30 stores the auxiliary display data 72 in the storing unit 70 via the main control unit 50, converts the auxiliary display data 72 to an image signal for display, and supplies it to the auxiliary display unit 322. Consequently, the auxiliary display unit 322 displays the display object 322a1 on the auxiliary display screen 322a as a display object obtained by enlarging part of the display object on the waveform display screen 311a1.

In Step S33, the main control unit 50 controls the display control unit 30 such that a plurality of button objects 322a2 to 322a4 linked to both the display object 311a3 on the main display screen 311a and the display object 322a1 on the auxiliary display screen 322a are displayed on the auxiliary display screen 322a.

For example, the main control unit 50 predicts operation candidates that are needed for displaying a waveform. For example, the main control unit 50 predicts “enlargement”, “reduction”, and “main” as operation candidates that are needed for I/F diagnosis (see FIG. 11(b)). The main control unit 50 supplies the predicted operation candidates, i.e., “enlargement”, “reduction”, and “main”, to the display control unit 30. The display control unit 30 generates, as the auxiliary display data 72, the button objects 322a2 to 322a4 (see FIG. 11(b)) corresponding to the operation candidates, i.e., “enlargement”, “reduction”, and “main”. The display control unit 30 stores the auxiliary display data 72 in the storing unit 70 via the main control unit 50, converts the auxiliary display data 72 to an image signal for display, and supplies it to the auxiliary display unit 322. Consequently, the auxiliary display unit 322 displays the button objects 322a2 to 322a4 on the auxiliary display screen 322a as information linked to both the display object 311a3 on the main display screen 311a and the display object 322a1 on the auxiliary display screen 322a.

In Step S34, the main control unit 50 controls the display control unit 30 such that a display object obtained by enlarging or reducing the display object 322a1 on the auxiliary display screen 322a is displayed on the auxiliary display screen 322a. Alternatively, the main control unit 50 controls the display control unit 30 such that the original display object 322a1 is displayed on the auxiliary display screen 322a after the display object 322a1 on the auxiliary display screen 322a is enlarged or reduced.

For example, when the main control unit 50 recognizes that the button object 322a2 for “enlargement” is pressed among the button objects 322a2 to 322a4 via the touch panel sensor 22b, the main control unit 50 notifies the display control unit 30 that the button object 322a2 for “enlargement” is pressed. In responds to this, the display control unit 30 further enlarges the display object 311a1 from the center of the region surrounded by the cursor 311a2 and displays it on the auxiliary display screen 322a1. At this point, both the cursor 311a2 and the display object 311a3 on the main display screen 311a are maintained in the state illustrated in FIG. 11(a); however, an operation equivalent to reducing the area of the portion surrounded by the cursor 311a2 in the display object 311a3 by reducing the size of the cursor 311a2 is actually performed.

Alternatively, for example, when the main control unit 50 recognizes that the button object 322a3 for “reduction” is pressed among the button objects 322a2 to 322a4 via the touch panel sensor 22b, the main control unit 50 notifies the display control unit 30 that the button object 322a3 for “reduction” is pressed. In response to this, the display control unit 30 reduces the display object 311a1 from the center of the region surrounded by the cursor 311a2 and displays it on the auxiliary display screen 322a1 as a display object 322a11 (see FIG. 11(c)). At this point, both the cursor 311a2 and the display object 311a3 on the main display screen 311a are maintained in the state illustrated in FIG. 11(a); however, an operation equivalent to enlarging the area of the portion surrounded by the cursor 311a2 in the display object 311a3 by enlarging the size of the cursor 311a2 is actually performed.

Alternatively, for example, when the main control unit 50 recognizes that the button object 322a4 for “main” is pressed among the button objects 322a2 to 322a4 via the touch panel sensor 22b, the main control unit 50 notifies the display control unit 30 that the button object 322a4 for “main” is pressed. In response to this, the display control unit 30 displays again, on the auxiliary display screen 322a1, the original display object 311a1, i.e., the display object 322a1 (see FIG. 11(b)) that is obtained by enlarging a partial display object, which is surrounded by the cursor 311a2, of the display object 311a3 displayed on the main display screen 311a such that it corresponds to the region that needs to be displayed on the auxiliary display screen 322a. At this point, both the cursor 311a2 and the display object 311a3 on the main display screen 311a are maintained in the state illustrated in FIG. 11(a); however, an operation equivalent to restoring the area of the portion surrounded by the cursor 311a2 in the display object 311a3 by restoring the size of the cursor 311a2 is actually performed.

In Step S35, the main control unit 50 determines whether it is requested to further check a waveform.

For example, when the input control unit 40 detects that an end instruction to end the waveform display screen 311a1 has been received from a user via at least one of the input keys 21 and the touch panel sensor 22b, the input control unit 40 supplies the detected end instruction to the main control unit 50.

When the end instruction is supplied from the input control unit 40 within a predetermined time, the main control unit 50 determines that it is not requested to display other coordinates and ends the process. When the end instruction is not supplied from the input control unit 40 within a predetermined time, the main control unit 50 determines that it is requested to display other coordinates and returns the process to Step S34.

As described above, in the fourth embodiment, the display control unit 30 displays the display object 311a3 on the main display screen 311a as the first machine-related information and displays the display object 322a1 corresponding to part of the display object 311a3 on the auxiliary display screen 322a as the second machine-related information. In other words, the display control unit 30 displays, on the auxiliary display screen 322a, the display object (partial waveform) 322a1, which is obtained by enlarging part of the display object (the entire waveform) 311a3 on the main display screen 311a. Consequently, the enlarged partial waveform can be checked while checking the whole image of the displayed waveform.

Moreover, in the fourth embodiment, the display control unit 30 displays, on the auxiliary display screen 322a, the button objects 322a2 to 322a4 linked to both the display object 311a3 (first machine-related information) on the main display screen 311a and the display object 322a1 (part of the second machine-related information) on the auxiliary display screen 322a as another part of the second machine-related information. The touch panel sensor 22b receives an input instruction corresponding to the pressed button object among the button objects 322a2 to 322a4. Consequently, it is possible to check the display object 322a1, which is selected from the display object 311a3 displayed on the waveform display screen 311a1 and is displayed on the auxiliary display screen 322a, by enlarging or reducing it and to restore the display object 322a1 to its original state (by canceling the operation performed on the auxiliary display screen 322a). As a result, the number of inputs with respect to an input instruction needed to check a waveform can be reduced and the number of screen transitions needed to check a waveform can be reduced.

In the flowchart illustrated in FIG. 10, the process in Step S32 and the process in Step S33 may be performed in parallel after the process in Step S31 is performed. Alternatively, the process in Step S33 may be performed after the process in Step S31 and the process in Step S32 are performed in parallel. Alternatively, the process in Step S31, the process in Step S32, and the process in Step S33 may be performed in parallel.

### Fifth Embodiment

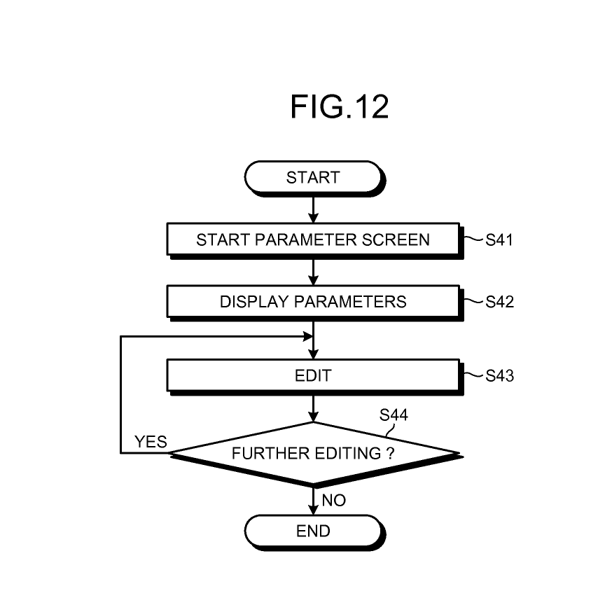

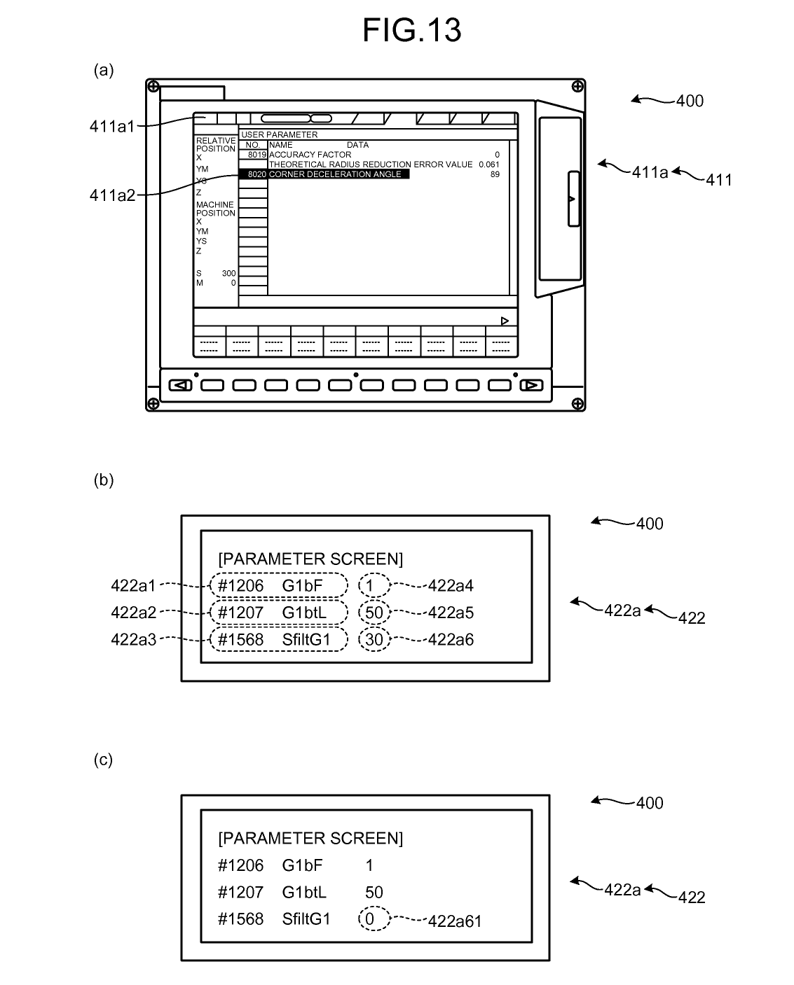

Next, an NC apparatus 400 according to the fifth embodiment will be explained with reference to FIG. 12 and FIG. 13. FIG. 12 is a flowchart illustrating operations of a main display screen 411a and an auxiliary display screen 422a according to the fifth embodiment. FIG. 13(a) is a diagram illustrating an operation of the main display screen 411a. FIGS. 13(b) and (c) are diagrams illustrating an operation of the auxiliary display screen 422a. In the following, the explanation concentrates on the portions that are different from the first embodiment.

In Step S41 illustrated in FIG. 12, the input control unit 40 detects that a start instruction to start a parameter screen has been received from a user via at least one of the input keys 21 and the touch panel sensor 22b. The input control unit 40 supplies the detected start instruction to the display control unit 30 via the main control unit 50.

The display control unit 30 generates a parameter screen 411a1 (see FIG. 13(a)) as the main display data 71 in accordance with the supplied start instruction. Then, the display control unit 30 stores the main display data 71 in the storing unit 70 via the main control unit 50, converts the main display data 71 to an image signal for display, and supplies it to a main display unit 411. Consequently, the main display unit 411 starts the parameter screen 411a1 and displays it on the main display screen 411a. At this point, the main display unit 411 displays a cursor (for example, the black square object illustrated in FIG. 13(a)) 411a2, which indicates the edit position, at a predetermined position on the parameter screen 411a1. For example, the main display unit 411 displays, on the main display screen 411a, a screen, as the parameter screen 411a1, for setting parameters (parameters of the NC) to specify the machine tool M to be controlled by the NC apparatus 400.

In Step S42, the main control unit 50 controls the display control unit 30 such that information linked to the display content of the parameter screen 411a1 is displayed on the auxiliary display screen 422a.

For example, a parameter of the NC has a plurality of relevant parameters, and when a new function is added, new parameter numbers are attached; therefore, the relevant parameters are often displayed on a different screen. The main control unit 50 predicts parameters relevant to the parameter displayed at the position at which the cursor 411a2 is present on the parameter screen 411a1. For example, the main control unit 50 predicts “#1206 G1bF”, “#1207 G1btL”, and “#1568 SfiltG1” as parameters relevant to “corner deceleration angle” on the parameter screen 411a1. The main control unit 50 obtains “1”, “50”, and “30” as values of the predicted parameters “#1206 G1bF”, “#1207 G1btL”, and “#1568 SfiltG1”, respectively. The main control unit 50 supplies the information on the predicted parameters and the information on the values to the display control unit 30. The display control unit 30 generates, as the auxiliary display data 72, a plurality of pieces of relevant parameter information 422a1 to 422a3 (see FIG. 13(b)) and a plurality of pieces of value information 422a4 to 422a6, which correspond to the information on the parameters and the information on the values, respectively. The display control unit 30 stores the auxiliary display data 72 in the storing unit 70 via the main control unit 50, converts the auxiliary display data 72 to an image signal for display, and supplies it to the auxiliary display unit 422. Consequently, the auxiliary display unit 422 displays the relevant parameter information 422a1 to 422a3 and the value information 422a4 to 422a6 on the auxiliary display screen 422a as information linked to the display content (selected parameter) of the parameter screen 411a1.

In Step S43, the display control unit 30 is controlled such that the relevant parameter information 422a1 to 422a3 and the value information 422a4 to 422a6 displayed on the auxiliary display unit 422 in Step S42 are edited.

For example, when the main control unit 50 recognizes that the portion “30” of the value information 422a6 with respect to the relevant parameter information 422a3 “#1568 SfiltG1” on the auxiliary display screen 422a is pressed via the touch panel sensor 22b, the main control unit 50 notifies the display control unit 30 that the portion “ ” after “Z” is pressed. In response to this, the display control unit 30 updates the auxiliary display data 72 in the storing unit 70 via the main control unit 50 and controls the auxiliary display unit 422 such that it displays an indication that a value can be input to the pressed portion “30” of the value information 422a6 (for example, by highlighting “30”).

Then, when the main control unit 50 recognizes that, for example, “0” is input as a value of “#1568 SfiltG1” via the input keys 21, the main control unit 50 notifies the display control unit 30 of the value “0” of “#1568 SfiltG1”. In response to this, the display control unit 30 updates the auxiliary display data 72 in the storing unit 70 via the main control unit 50 and controls the auxiliary display unit 422 such that it displays an indication that “0” is input to the pressed portion “30” of the value information 422a6 (in other words, displaying new value information 422a61).

In Step S44, the main control unit 50 determines whether it is requested to perform further editing.

For example, when the input control unit 40 detects that an end instruction to end the parameter screen 411a1 has been received from a user via at least one of the input keys 21 and the touch panel sensor 22b, the input control unit 40 supplies the detected end instruction to the main control unit 50.

When the end instruction is supplied from the input control unit 40 within a predetermined time, the main control unit 50 determines that it is not requested to perform further editing and ends the process. When the end instruction is not supplied from the input control unit 40 within a predetermined time, the main control unit 50 determines that it is requested to perform further editing and returns the process to Step S43.

As described above, in the fifth embodiment, the display control unit 30 displays, on the auxiliary display screen 422a, information linked to the display content (first machine-related information) of the parameter screen 411a1 as the second machine-related information. In other words, the display control unit 30 displays a parameter (first parameter) of the NC selected on the parameter screen 411a1 as the first machine-related information and displays, on the auxiliary display screen 422a, the relevant parameter information 422a1 to 422a3 (a plurality of second parameters) and the value information 422a4 to 422a6, which are relevant to the parameter of the NC, as the second machine-related information. Consequently, when parameters relevant to a parameter of the NC need to be checked at the same time as the parameter of the NC, both of them can be checked without causing the parameter screen 411a1 on the main display screen 411a to transition to the relevant parameter screen. Therefore, the necessary number of screen transitions can be reduced and thus the operability can be improved.

### Sixth Embodiment

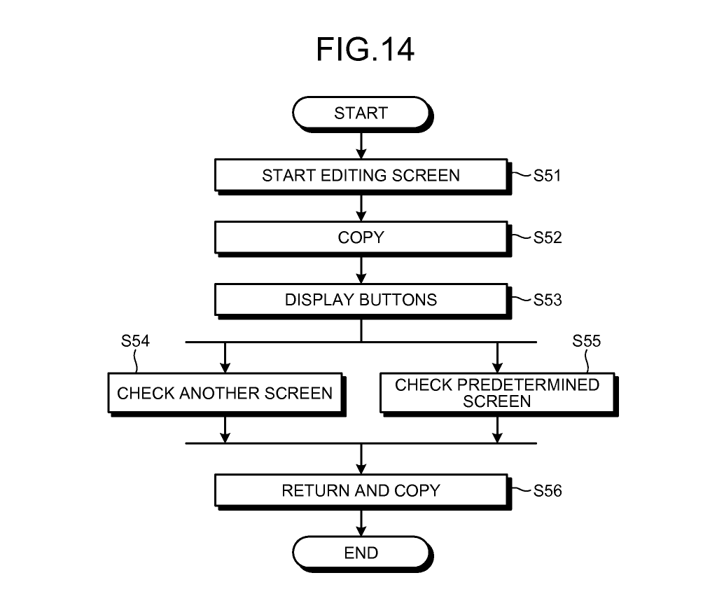

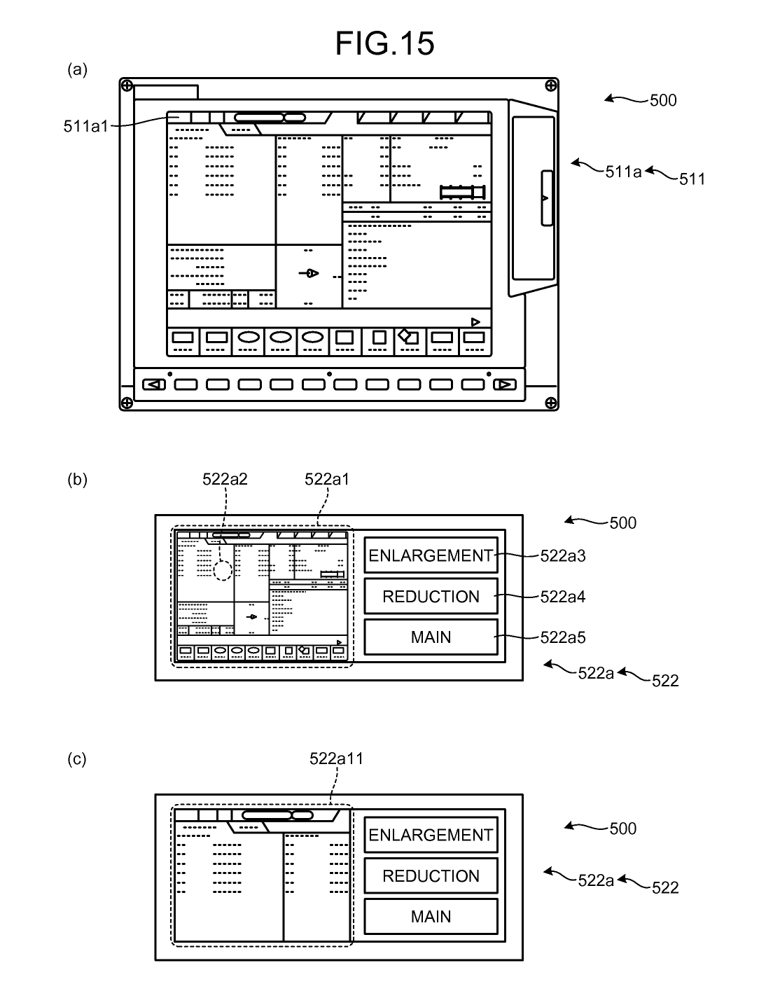

Next, an NC apparatus 500 according to the sixth embodiment will be explained with reference to FIG. 14 and FIG. 15. FIG. 14 is a flowchart illustrating operations of a main display screen 511a and an auxiliary display screen 522a according to the sixth embodiment. FIG. 15(a) is a diagram illustrating an operation of the main display screen 511a. FIGS. 15(b) and (c) are diagrams illustrating an operation of the auxiliary display screen 522a. In the following, the explanation concentrates on the portions that are different from the first embodiment.

In Step S51 illustrated in FIG. 14, the input control unit 40 detects that a start instruction to start a predetermined screen has been received from a user via at least one of the input keys 21 and the touch panel sensor 22b. The input control unit 40 supplies the detected start instruction to the display control unit 30 via the main control unit 50.

The display control unit 30 generates a predetermined screen 511a1 (see FIG. 15(a)) as the main display data 71 in accordance with the supplied start instruction. Then, the display control unit 30 stores the main display data 71 in the storing unit 70 via the main control unit 50, converts the main display data 71 to an image signal for display, and supplies it to a main display unit 511. Consequently, the main display unit 511 starts the predetermined screen 511a1 and displays it on the main display screen 511a.

In Step S52, the main control unit 50 controls the display control unit 30 such that a display object on the main display screen 511a, i.e., a display object obtained by reducing the whole of the predetermined screen 511a1, is displayed on (copied to) the auxiliary display screen 522a.

For example, the main control unit 50 specifies a display object (the whole of the predetermined screen 511a1) on the main display screen 511a. The main control unit 50 supplies the specified display object (the whole of the predetermined screen 511a1) to the display control unit 30. The display control unit 30 generates, as the auxiliary display data 72, a display object 522a1 (see FIG. 15(b)), which is obtained by reducing the display object (the whole of the predetermined screen 511a1) such that it corresponds to the region that needs to be displayed on the auxiliary display screen 522a. The display control unit 30 stores the auxiliary display data 72 in the storing unit 70 via the main control unit 50, converts the auxiliary display data 72 to an image signal for display, and supplies it to an auxiliary display unit 522. Consequently, the auxiliary display unit 522 displays the display object 522a1 on the auxiliary display screen 522a as a display object obtained by reducing the whole of the display object (the whole of the predetermined screen 511a1) on the main display screen 511a.

In Step S53, the main control unit 50 controls the display control unit 30 such that a plurality of button objects 522a3 to 522a5 linked to the display object 522a1 on the auxiliary display screen 522a are displayed on the auxiliary display screen 522a.

For example, the main control unit 50 predicts operation candidates that are needed for the display object 522a1. For example, the main control unit 50 predicts “enlargement”, “reduction”, and “main” as operation candidates that are needed for checking the predetermined screen 511a1 (see FIG. 15(b)). The main control unit 50 supplies the predicted operation candidates, i.e., “enlargement”, “reduction”, and “main”, to the display control unit 30. The display control unit 30 generates, as the auxiliary display data 72, the button objects 522a3 to 522a5 (see FIG. 15(b)) corresponding to the operation candidates, i.e., “enlargement”, “reduction”, and “main”. The display control unit 30 stores the auxiliary display data 72 in the storing unit 70 via the main control unit 50, converts the auxiliary display data 72 to an image signal for display, and supplies it to the auxiliary display unit 522. Consequently, the auxiliary display unit 522 displays the button objects 522a3 to 522a5 on the auxiliary display screen 522a as information linked to the display object 522a1 on the auxiliary display screen 522a.

After the button objects 522a3 to 522a5 are displayed, the process in Step S54 and the process in Step S55 are performed in parallel.

In Step S54, the main control unit 50 controls the display control unit 30 such that another screen (not illustrated) is displayed on the main display screen 511a. In other words, in Step S54, a user checks another screen on the main display screen 511a.

For example, the input control unit 40 detects that a transition instruction to transition to another screen has been received from a user via at least one of the input keys 21 and the touch panel sensor 22b. The input control unit 40 supplies the detected transition instruction to the display control unit 30 via the main control unit 50.

The display control unit 30 generates another screen as the main display data 71 in accordance with the supplied transition instruction. Then, the display control unit 30 updates the main display data 71 in the storing unit 70 via the main control unit 50, converts the main display data 71 to an image signal for display, and supplies it to the main display unit 511. Consequently, the main display unit 511 displays another screen on the main display screen 511a.

In Step S55, the main control unit 50 controls the display control unit 30 such that a display object obtained by enlarging or reducing the display object 522a1 on the auxiliary display screen 522a is displayed on the auxiliary display screen 522a. In other words, in Step S55, a user checks a predetermined screen on the auxiliary display screen 522a.

For example, when the main control unit 50 recognizes that a portion 522a2 of the display object 522a1 is pressed via the touch panel sensor 22b and the button object 522a3 for “enlargement” is pressed, the main control unit 50 notifies the display control unit 30 of the position of the portion 522a2 and notifies the display control unit 30 that the button object 522a3 for “enlargement” is pressed. In response to this, the display control unit 30 further enlarges the display object 522a1 centered on the position of the portion 522a2 and displays it on the auxiliary display screen 522a as a display object 522a11 (see FIG. 15(c)). At this point, the display control unit 30 stores in the storing unit 70 the data of the original display object 522a1 before being enlarged or reduced as backup data (not illustrated) via the main control unit 50.

Alternatively, for example, when the main control unit 50 recognizes that the portion 522a2 of the display object 522a1 is pressed via the touch panel sensor 22b and the button object 522a4 for “reduction” is pressed, the main control unit 50 notifies the display control unit 30 of the position of the portion 522a2 and notifies the display control unit 30 that the button object 522a4 for “reduction” is pressed. In response to this, the display control unit 30 further reduces the display object 522a1 centered on the position of the portion 522a2 and displays it on the auxiliary display screen 522a. At this point, the display control unit 30 stores in the storing unit 70 the data of the original display object 522a1 before being enlarged or reduced as backup data (not illustrated) via the main control unit 50.

Then, when the main control unit 50 recognizes that the button object 522a5 for “main” is pressed via the touch panel sensor 22b, the main control unit 50 determines that both the process in Step S54 and the process in Step S55 are finished.

In Step S56, the main control unit 50 controls the display control unit 30 such that a display object obtained by enlarging the display object 522a1 on the auxiliary display screen 522a is displayed on (returned and copied to) the main display screen 511a again.

For example, when the main control unit 50 recognizes that the button object 522a5 for “main” is pressed among the button objects 522a3 to 522a5 via the touch panel sensor 22b, the main control unit 50 notifies the display control unit 30 that the button object 522a5 for “main” is pressed. In response to this, the display control unit 30 reads the backup data from the storing unit 70 via the main control unit 50 and displays the original display object (the whole of the predetermined screen 511a1) on the main display screen 511a again. In other words, the display control unit 30 displays again, on the main display screen 511a, a display object (the predetermined screen 511a1) that is restored on the basis of the backup data and is obtained by enlarging the display object 522a1 on the auxiliary display screen 522a such that it corresponds to the region that needs to be displayed on the main display screen 511a.

As described above, in the sixth embodiment, the display control unit 30 displays the display object 522a1, which is obtained by reducing the whole of the display object (the whole of the predetermined screen 511a1) on the main display screen 511a, on the auxiliary display screen 522a. In other words, after the display control unit 30 displays the display object 522a1, which is obtained by reducing the whole of the display object (the whole of the predetermined screen 511a1) on the main display screen 511a, on the auxiliary display screen 522a, the display control unit 30 displays, on the main display screen 511a again, a display object (the whole of the predetermined screen 511a1) obtained by enlarging the display object 522a1 on the auxiliary display screen 522a. Consequently, the content that was copied once to the auxiliary display screen 522a can be returned to the main display screen 511a. In other words, after another screen is referred to after a frequently referenced screen is checked, if it is necessary to return to the frequently referenced screen and check the screen, the frequently referenced screen does not need to be searched for by causing the screen on the main display screen 511a to transition. Therefore, the necessary number of screen transitions can be reduced and thus the operability can be improved.

Moreover, in the sixth embodiment, the process of displaying and checking another screen on the main display screen 511a and the process of checking the display object 522a1 displayed on the auxiliary display unit 522 by enlarging or reducing the display object 522a1 are performed in parallel. Consequently, when another screen needs to be referred to while checking the screen that is always referred to, the necessary number of screen transitions can be reduced and thus the operability can be improved.

In Step S56, the display control unit 30 may cause the state to transition from the state where the first machine-related information is displayed on the main display screen 511a and the second machine-related information is displayed on the auxiliary display screen 522a to the state where the second machine-related information is displayed on the main display screen 511a and the first machine-related information is displayed on the auxiliary display screen 522a.

For example, the main control unit 50 specifies a display object (the whole of another screen) on the main display screen 511a. The main control unit 50 supplies the specified display object (the whole of another screen) to the display control unit 30. The display control unit 30 generates, as the auxiliary display data 72, a display object (not illustrated) obtained by reducing the display object (the whole of another screen) such that it corresponds to the region that needs to be displayed on the auxiliary display screen 522a. The display control unit 30 stores the auxiliary display data 72 in the storing unit 70 via the main control unit 50, converts the auxiliary display data 72 to an image signal for display, and supplies it to the auxiliary display unit 522. Consequently, the auxiliary display unit 522 displays, on the auxiliary display screen 522a, the display object obtained by reducing the whole of the display object (the whole of another screen) on the main display screen 511a.

In addition, when the main control unit 50 recognizes that the button object 522a5 for “main” is pressed among the button objects 522a3 to 522a5 via the touch panel sensor 22b, the main control unit 50 notifies the display control unit 30 that the button object 522a5 for “main” is pressed. In responds to this, the display control unit 30 reads the backup data from the storing unit 70 via the main control unit 50 and displays the original display object (the whole of the predetermined screen 511a1) on the main display screen 511a again.

As described above, the process of returning and copying a display object on the auxiliary display screen 522a to the main display screen 511a and the process of copying a display object on the main display screen 511a to the auxiliary display screen 522a are performed in parallel. Therefore, after a frequently referenced screen is checked, another screen is referred to, and then the screen is returned to the frequently referenced screen and the frequently referenced screen is checked, if another screen needs to be referred to again, it is not necessary to search for another screen by causing the screen on the main display screen 511a to transition. Therefore, the necessary number of screen transitions can be reduced and thus the operability can be improved.

### INDUSTRIAL APPLICABILITY

As described above, the numerical control apparatus according to the present invention is useful for controlling a machine tool.

### Reference Signs List

1, 100, 200 NC apparatus
10 display unit
10a main surface
11, 111, 211, 311, 411, 511 main display unit
11a, 111a, 211a, 311a, 411a, 511a main display screen
20 keyboard unit
20a operation surface
21a plurality of input keys
22, 122, 222, 322, 422, 522 auxiliary display unit
22a, 122a, 222a, 322a, 422a, 522a auxiliary display screen
22b touch panel sensor
50 main control unit
60 screen coordinate calculating unit
70 storing unit
71 main display data
72 auxiliary display data
73 machining program
74 input instruction data
80 driving unit
81 drive amplifier
900 NC apparatus
910 display unit
911 display part
911a display screen
M machine tool
W workpiece

1. A numerical control apparatus that controls a machine tool comprising:
a display unit that includes a main display screen on a main surface;
a keyboard unit that includes a plurality of physical input keys and an auxiliary display screen on an operation surface; and
a display control unit that displays first machine-related information related to the machine tool on the main display screen and displays second machine-related information related to the machine tool on the auxiliary display screen, wherein
the display unit and the keyboard unit are physically separated from each other, and
the keyboard unit includes a display input unit that receives an input instruction by using the auxiliary display screen as a touch panel,
when the numerical control apparatus is used by a user, the operation surface is located lower than the main surface,
the auxiliary display screen is arranged along with the physical input keys in a direction along the main display screen on the operation surface and is arranged at a position closer to the main display screen than the physical input keys on the operation surface,
the display control unit displays a plurality of button objects on the auxiliary display screen while maintaining a state where a button object is not displayed on the main display screen, and
the display input unit receives an input instruction corresponding to a pressed button object among the button objects.

2. The numerical control apparatus according to claim 1, wherein
the display control unit displays, on the auxiliary display screen, a plurality of button objects linked to the first machine-related information as part of the second machine-related information.

3. The numerical control apparatus according to claim 1, wherein
the display control unit displays, on the auxiliary display screen, a plurality of button objects linked to part of the second machine-related information as another part of the second machine-related information.

4. The numerical control apparatus according to claim 1, wherein
the display control unit displays, on the auxiliary display screen, a plurality of button objects linked to both the first machine-related information and part of the second machine-related information as another part of the second machine-related information.

5. The numerical control apparatus according to claim 2, wherein
the display control unit displays, on the main display screen, a machining program being edited as the first machine-related information and displays, on the auxiliary display screen, a plurality of button objects corresponding to a plurality of codes that are candidates to be added next to the machining program being edited as part of the second machine-related information.

6. The numerical control apparatus according to claim 5, wherein the display control unit displays, on the auxiliary display screen, a character string that is expected to be input next to a code corresponding to selected button object as another part of the second machine-related information.

7. The numerical control apparatus according to claim 1, wherein the display control unit displays, on the auxiliary display screen, information linked to the first machine-related information as the second machine-related information.

8. The numerical control apparatus according to claim 7, wherein the display control unit displays, on the main display screen, a first parameter as the first machine-related information and displays, on the auxiliary display screen, a second parameter linked to the first parameter as the second machine-related information.

9. The numerical control apparatus according to claim 7, wherein the display control unit displays, on the main display screen, a first display object as the first machine-related information and displays, on the auxiliary display screen, a second display object corresponding to part of the first display object as the second machine-related information.

10. The numerical control apparatus according to claim 9, wherein the display control unit displays, on the auxiliary display screen, a display object obtained by enlarging part of the first display object as the second display object.

11. The numerical control apparatus according to claim 9, wherein the display control unit displays, on the auxiliary display screen, a display object obtained by reducing a whole of the first display object as the second display object.

12. The numerical control apparatus according to claim 11, wherein after displaying, on the auxiliary display screen, the second display object obtained by reducing a whole of the first display object, the display control unit displays again, on the main display screen, a display object obtained by enlarging the second display object as the first display object.

13. The numerical control apparatus according to claim 1, wherein the display control unit causes a state to transition from a state where the first machine-related information is displayed on the main display screen and the second machine-related information is displayed on the auxiliary display screen to a state where the second machine-related information is displayed on the main display screen and the first machine-related information is displayed on the auxiliary display screen.
